(19) United States
(12) Patent Application Publication
(10) Pub. No.: US 2022/0217256 A1
(43) Pub. Date: Jul. 7, 2022

(54) ZOOM LENS AND IMAGE PICKUP APPARATUS INCLUDING ZOOM LENS

(71) Applicant: OM DIGITAL SOLUTIONS CORPORATION, Tokyo (JP)

(72) Inventors: Shun ITO, Tokyo (JP); Kenichi NAGASAWA, Tokyo (JP); Toyoki KON, Tokyo (JP)

(73) Assignee: OM DIGITAL SOLUTIONS CORPORATION, Tokyo (JP)

(21) Appl. No.: 17/704,461

(22) Filed: Mar. 25, 2022

Related U.S. Application Data
(63) Continuation of application No. PCT/JP2019/039836, filed on Oct. 9, 2019.

(51) Int. Cl. H04N 5/225; G02B 15/14

(52) U.S. Cl. CPC H04N 5/2254; G02B 15/145121

(57) ABSTRACT

A zoom lens having a large magnification ratio, small F-number change at zooming, and excellently corrected various aberrations, and an image pickup apparatus including the zoom lens are provided. The zoom lens includes a common optical system. The common optical system includes, sequentially from an object side, a first lens group G1 having positive refractive power, a second lens group G2 having negative refractive power, a third lens group G3 having positive refractive power, a fourth lens group G4 having negative refractive power, and a fifth lens group G5 having positive refractive power. In the common optical system, all intervals between each pair of adjacent lens groups change at zooming, and a distance between the fifth lens group G5 and an image plane is constant.

### CROSS REFERENCE TO RELATED APPLICATION

This application is a continuation application of PCT/JP2019/039836 filed on Oct. 9, 2019, the entire contents of which are incorporated herein by this reference.

### BACKGROUND OF THE INVENTION

### 1. Field of the Invention

The present invention relates to a zoom lens and an image pickup apparatus including the zoom lens.

### 2. Description of the Related Art

A zoom lens including five lens groups is disclosed in Japanese Patent Application Laid-Open Publication No. 2018-004717, Japanese Patent Application Laid-Open Publication No. 2011-237588, and the like. The zoom lens disclosed in the publications and the like includes, sequentially from an object side, a first lens group having positive refractive power, a second lens group having negative refractive power, a third lens group having positive refractive power, a fourth lens group having negative refractive power, and a fifth lens group having positive refractive power.

### SUMMARY OF THE INVENTION

A zoom lens according to a first aspect of the present invention includes, sequentially from an object side:

a first lens group having positive refractive power;

a second lens group having negative refractive power;

a third lens group having positive refractive power;

a fourth lens group having negative refractive power; and

a fifth lens group having positive refractive power.

All intervals between each pair of adjacent lens groups change at zooming.

A distance between the fifth lens group and an image plane is constant.

The third lens group includes, sequentially from the object side, a first positive lens, a second positive lens, and a cemented lens.

The first positive lens and the second positive lens are single lenses.

The cemented lens includes a negative lens and a positive lens.

The zoom lens satisfies condition expressions (1) and (2) below:

1.63≤nd3f≤1.94 (1)

−0.39≤(1/f3b)/(1/f3)≤0.20 (2)

where,

nd3f represents a refractive index of the first positive lens disposed closest to the object side in the third lens group at a d line,

f3b represents a focal length of the cemented lens disposed closest to an image side in the third lens group, and

f3 represents a focal length of the third lens group.

A zoom lens according to a second aspect of the present invention includes, sequentially from an object side:

a first lens group having positive refractive power;

a second lens group having negative refractive power;

a third lens group having positive refractive power;

a fourth lens group having negative refractive power; and

a fifth lens group having positive refractive power.

All intervals between each pair of adjacent lens groups change at zooming.

A distance between the fifth lens group and an image plane is constant.

The second lens group includes three or more negative lenses.

The fourth lens group includes one single lens.

The fifth lens group includes one single lens.

The fourth lens group moves along an optical axis at focusing.

The zoom lens satisfies a condition expression (4) below:

0.59≤|f4|/|f5|≤0.91 (4)

where,

f4 represents a focal length of the fourth lens group, and

f5 represents a focal length of the fifth lens group.

A zoom lens according to a third aspect of the present invention includes, sequentially from an object side:

a first lens group having positive refractive power;

a second lens group having negative refractive power;

a third lens group having positive refractive power;

a fourth lens group having negative refractive power; and

a fifth lens group having positive refractive power.

All intervals between each pair of adjacent lens groups change at zooming.

A distance between the fifth lens group and an image plane is constant.

The third lens group includes a positive lens disposed closest to the object side.

The zoom lens satisfies condition expressions (6), (7), and (8) below:

1.00≤d23w/fw≤1.94 (6)

1.24≤|f3|/|f2|≤1.48 (7)

1.63≤nd3o≤1.94 (8)

where,

d23w represents an air interval between the second lens group and the third lens group at a wide-angle end,

fw represents a focal length of a whole system of the zoom lens at the wide-angle end,

f2 represents a focal length of the second lens group,

f3 represents a focal length of the third lens group, and

nd3o represents a refractive index of the positive lens disposed closest to the object side in the third lens group at a d line.

A zoom lens according to a fourth aspect of the present invention includes, sequentially from an object side:

a first lens group having positive refractive power;

a second lens group having negative refractive power;

a third lens group having positive refractive power;

a fourth lens group having negative refractive power; and

a fifth lens group having positive refractive power.

All intervals between each pair of adjacent lens groups change at zooming.

A distance between the fifth lens group and an image plane is constant.

The third lens group includes a positive lens disposed closest to the object side.

The zoom lens satisfies condition expressions (7), (8), and (9) below:

1.24≤|f3|/|f2|≤1.48 (7)

1.63≤nd3o≤1.94 (8)

5.00≤|f1|/|f2|≤8.74 (9)

where,

f1 represents a focal length of the first lens group,

f2 represents a focal length of the second lens group,

f3 represents a focal length of the third lens group, and

nd3o represents a refractive index of the positive lens disposed closest to the object side in the third lens group at a d line.

A zoom lens according to a fifth aspect of the present invention includes, sequentially from an object side:

a first lens group having positive refractive power;

a second lens group having negative refractive power;

a third lens group having positive refractive power;

a fourth lens group having negative refractive power; and

a fifth lens group having positive refractive power.

All intervals between each pair of adjacent lens groups change at zooming.

A distance between the fifth lens group and an image plane is constant.

The first lens group is one cemented lens including a negative lens and a positive lens.

The cemented lens includes an object-side lens positioned closest to the object side and an image-side lens positioned closest to an image side.

The zoom lens satisfies condition expressions (10) and (11) below:

1.73≤|f1|/ft≤2.34 (10)

0.08≤|nd11−nd12|≤0.17 (11)

where,

f1 represents a focal length of the first lens group,

ft represents a focal length of a whole system of the zoom lens at a telephoto end,

nd11 represents a refractive index of the object-side lens positioned closest to the object side among lenses included in the cemented lens disposed in the first lens group at a d line, and

nd12 represents a refractive index of the image-side lens positioned closest to the image side among lenses included in the cemented lens disposed in the first lens group at the d line.

An image pickup apparatus according to an aspect of the present invention includes:

an optical system; and

an image pickup device disposed on an image plane.

The image pickup device includes an image pickup surface and converts an image formed on the image pickup surface through the optical system into an electric signal.

The optical system is an above-described zoom lens.

### BRIEF DESCRIPTION OF THE DRAWINGS

FIG. 1 is a lens cross-sectional view of a zoom lens of Example 1;

FIG. 2 is a lens cross-sectional view of a zoom lens of Example 2;

FIG. 3 is a lens cross-sectional view of a zoom lens of Example 3;

FIG. 4 is a lens cross-sectional view of a zoom lens of Example 4;

FIG. 5 is a lens cross-sectional view of a zoom lens of Example 5;

FIG. 6 is a lens cross-sectional view of a zoom lens of Example 6;

FIG. 7 is a lens cross-sectional view of a zoom lens of Example 7;

FIG. 8 is a lens cross-sectional view of a zoom lens of Example 8;

FIGS. 9A, 9B, 9C, 9D, 9E, 9F, 9G, 9H, 9I, 9J, 9K, and 9L are aberration diagrams of the zoom lens of Example 1;

FIGS. 10A, 10B, 10C, 10D, 10E, 10F, 10G, 10H, 10I, 10J, 10K, and 10L are aberration diagrams of the zoom lens of Example 2;

FIGS. 11A, 11B, 11C, 11D, 11E, 11F, 11G, 11H, 11I, 11J, 11K, and 11L are aberration diagrams of the zoom lens of Example 3;

FIGS. 12A, 12B, 12C, 12D, 12E, 12F, 12G, 12H, 12I, 12J, 12K, and 12L are aberration diagrams of the zoom lens of Example 4;

FIGS. 13A, 13B, 13C, 13D, 13E, 13F, 13G, 13H, 13I, 13J, 13K, and 13L are aberration diagrams of the zoom lens of Example 5;

FIGS. 14A, 14B, 14C, 14D, 14E, 14F, 14G, 14H, 14I, 14J, 14K, and 14L are aberration diagrams of the zoom lens of Example 6;

FIGS. 15A, 15B, 15C, 15D, 15E, 15F, 15G, 15H, 15I, 15J, 15K, and 15L are aberration diagrams of the zoom lens of Example 7;

FIGS. 16A, 16B, 16C, 16D, 16E, 16F, 16G, 16H, 16I, 16J, 16K, and 16L are aberration diagrams of the zoom lens of Example 8;

FIG. 17 is a cross-sectional view of an image pickup apparatus;

FIG. 18 is a front perspective view of the image pickup apparatus;

FIG. 19 is a back perspective view of the image pickup apparatus; and

FIG. 20 is a configuration block diagram of an internal circuit of a main part of the image pickup apparatus.

### DETAILED DESCRIPTION OF THE PREFERRED EMBODIMENTS

Before description of examples, effects of an embodiment according to an aspect of the present invention will be described. Note that the effects of the present embodiment will be specifically described with reference to specific examples. However, similarly to cases of the examples to be described later, exemplarily described aspects are merely some of aspects included in the present invention, and there are a large number of variations of the aspects. Thus, the present invention is not limited to the exemplarily described aspects.

A zoom lens of the present embodiment includes a common optical system. The common optical system includes, sequentially from an object side, a first lens group having positive refractive power, a second lens group having negative refractive power, a third lens group having positive refractive power, a fourth lens group having negative refractive power, and a fifth lens group having positive refractive power. In the common optical system, an interval between each pair of adjacent lens groups changes at zooming, and a distance between the fifth lens group and an image plane is constant.

The common optical system includes a plurality of lens groups. An optical image of an object is formed through the plurality of lens groups.

The plurality of lens groups includes, sequentially from the object side, a first lens group having positive refractive power, a second lens group having negative refractive power, a third lens group having positive refractive power, a fourth lens group having negative refractive power, and a fifth lens group having positive refractive power.

In a zoom lens, a value of an F number is likely to be large at a telephoto end. In the common optical system, the first lens group has positive refractive power, and the second lens group has negative refractive power. Thus, the value of the F number can be reduced at the telephoto end. In other words, sufficient brightness can be obtained at the telephoto end.

Refractive powers on the object side of the third lens group are in order of negative refractive power and positive refractive power toward the object side. Refractive powers on an image side of the third lens group are in order of negative refractive power and positive refractive power toward the image side.

In this manner, order of refractive powers is symmetric with respect to the third lens group in the common optical system. Thus, it is possible to suppress generation of various aberrations, in particular, generation of distortion.

Three lens groups, namely, the first lens group, the second lens group, and the third lens group are disposed on the object side of the fourth lens group. The negative refractive power of the fourth lens group allows size reduction of the three lens groups.

The positive refractive power of the fifth lens group allows reduction of an incident angle of each principal ray onto the image plane. As a result, it is possible to prevent generation of false color.

In the common optical system, distances between each pair of adjacent lens groups of the first lens group, the second lens group, the third lens group, the fourth lens group, and the fifth lens group change at zooming. In other words, in the common optical system, all intervals between each pair of adjacent lens groups change at zooming.

Thus, for example, the second lens group and the third lens group can be moved at zooming. Accordingly, the second lens group and the third lens group can have a main magnification-varying function.

In the common optical system, the distance between the fifth lens group and the image plane is constant at zooming. The fifth lens group is fixed at zooming. Thus, effects (I), (II), and (III) below are obtained.

(I) Dust-proof performance and drip-proof performance can be improved.
(II) High quietness can be obtained at zooming.
(III) Number of lens groups that move can be reduced. Thus, it is possible to reduce weight of a unit including the zoom lens and a drive unit.

Configurations and condition expressions that can be applied to the zoom lens of the present embodiment will be described below.

In the zoom lens of the present embodiment, the first lens group may be one cemented lens including a negative lens and a positive lens. The cemented lens may include an object-side lens positioned closest to the object side and an image-side lens positioned closest to the image side.

The first lens group includes a cemented lens. The cemented lens includes a negative lens and a positive lens. Chromatic aberration can be excellently corrected through the cemented lens.

In the zoom lens of the present embodiment, an object-side lens may be the negative lens of the cemented lens. In addition, an image-side lens may be the positive lens of the cemented lens.

With the configuration, it is possible to excellently correct chromatic aberration.

In the zoom lens of the present embodiment, the second lens group may include three or more negative lenses.

When a total length of the optical system changes at zooming, it is preferable to suppress increase of the total length of the optical system. Change of the total length of the optical system at zooming can be suppressed by increasing a magnification-varying effect of a lens group that moves at zooming.

As described above, in the common optical system, the second lens group can be moved at zooming. In this case, the second lens group has a main magnification-varying function. A moving amount of a lens group that moves at zooming can be reduced by increasing the magnification-varying effect of the second lens group. As a result, change of the total length of the optical system at zooming can be suppressed.

The magnification-varying effect of the second lens group can be increased by increasing the refractive power of the second lens group. Thus, change of the total length of the optical system at zooming can be suppressed by increasing the refractive power of the second lens group. However, a generation amount of various aberrations at the second lens group increases as the refractive power of the second lens group increases.

In a zoom lens of a second embodiment, the second lens group includes three or more negative lenses. Thus, the refractive power of the second lens group can be distributed to three negative lenses. Thus, it is possible to suppress increase of the generation amount of aberrations even if the refractive power of the second lens group increases. As a result, change of the total length of the optical system at zooming can be suppressed without increase of the generation amount of various aberrations.

At a wide-angle end, an off-axis light beam is incident on the second lens group at a large angle. The off-axis light beam is preferably aligned in substantially parallel to an optical axis through the second lens group to suppress generation of aberrations at lens groups positioned on the image side of the second lens group.

Negative refractive power is needed to align the off-axis light beam in substantially parallel to the optical axis. Since the refractive power of the second lens group is negative refractive power, the second lens group includes a negative lens. However, a generation amount of distortion and a generation amount of a curvature of field increase when the off-axis light beam is aligned in substantially parallel to the optical axis through one negative lens.

As described above, in the zoom lens of the second embodiment, the second lens group includes three or more negative lenses. In this case, the off-axis light beam is gradually refracted through the three negative lenses. Thus, increase of the generation amount of distortion and increase of the generation amount of a curvature of field can be suppressed. As a result, the off-axis light beam can be aligned in substantially parallel to the optical axis without increase of the generation amount of distortion and the generation amount of a curvature of field.

In the zoom lens of the present embodiment, the second lens group may include, sequentially from the object side, a negative lens, a negative lens, a positive lens, and a negative lens.

As described above, the off-axis light beam is preferably aligned in substantially parallel to the optical axis through the second lens group. Since the two negative lenses are disposed on the object side, the off-axis light beam can be gradually refracted through the two negative lenses. Thus, increase of the generation amount of distortion and increase of the generation amount of a curvature of field can be suppressed. As a result, the off-axis light beam can be aligned in substantially parallel to the optical axis without increase of the generation amount of distortion and the generation amount of a curvature of field.

Favorable correction of chromatic aberration of magnification at the wide-angle end and favorable correction of axial chromatic aberration at the telephoto end are required for the second lens group. Since the positive lens is disposed on the image side of the two negative lenses, chromatic aberration of magnification at the wide-angle end and axial chromatic aberration at the telephoto end can be excellently corrected.

A curvature of field and coma aberration remain despite the aberration correction through the two negative lenses and the positive lens. Since the negative lens is disposed on the image side of the positive lens, the curvature of field and the coma aberration that remain can be corrected.

In the zoom lens of the present embodiment, the third lens group may include, sequentially from the object side, a first positive lens, a second positive lens, and a cemented lens.

In the third lens group, it is preferable to reduce generated axial chromatic aberration through the whole third lens group. A generation amount of axial chromatic aberration can be effectively reduced by disposing a cemented lens in the third lens group. Thus, in a zoom lens of a first embodiment, a cemented lens is disposed in the third lens group.

With the cemented lens, an effect of suppressing generation of axial chromatic aberration can be increased as a cemented surface has a smaller curvature radius. However, when the curvature radius of the cemented surface is small, high-order aberration, in particular, high-order coma aberration is generated as light beam height at the cemented surface is higher. When the high-order aberration is generated, it is difficult to excellently correct coma aberration through the whole third lens group.

In the zoom lens of the present embodiment, the first positive lens and the second positive lens are disposed in the third lens group. Since the cemented lens is disposed closest to the image side, the first positive lens and the second positive lens are disposed on the object side of the cemented lens.

Since the two positive lenses are disposed on the object side of the cemented lens, the light beam height at the cemented surface can be lowered by the two positive lenses. As a result, it is possible to suppress generation of high-order aberration, in particular, high-order coma aberration at the cemented surface.

In the zoom lens of the present embodiment, the third lens group may include a positive lens disposed closest to the object side.

In the zoom lens of the present embodiment, the fourth lens group may include one single lens.

Since the number of lenses in the fourth lens group is one, the total length of the optical system can be reduced.

In the zoom lens of the present embodiment, the fourth lens group may move along the optical axis at focusing.

At focusing, the fourth lens group moves along the optical axis. As described above, the fourth lens group includes one single lens. Thus, at focusing, moving speed of the fourth lens group can be increased. As a result, it is possible to swiftly focus on an object.

At focusing, driving sound is generated along with movement of the fourth lens group. The driving sound can be reduced by fixing the fifth lens group at focusing. As a result, high quietness can be obtained at focusing.

In shooting of a moving image, an object needs to be constantly focused on. Thus, driving sound of a focusing group is frequently generated during shooting of a moving image. The driving sound is noise. The driving sound of the focusing group can be reduced by fixing the fifth lens group at focusing. As a result, the noise recorded in the moving image can be reduced.

In the zoom lens of the present embodiment, the fifth lens group may include one single lens.

Since the number of lenses in the fifth lens group is one, the total length of the optical system can be reduced.

The zoom lens of the present embodiment may include a brightness aperture between a surface of the second lens group on the image side and a surface of the third lens group on the object side.

With the configuration, the brightness aperture can be disposed near the third lens group. As described above, the order of refractive powers is symmetric with respect to the third lens group in the common optical system. Accordingly, the order of refractive powers is symmetric with respect to the brightness aperture. As a result, generation of various aberrations can be suppressed.

Since generation of various aberrations can be suppressed, the optical system can be configured by a smaller number of lenses. As a result, the optical system can be downsized.

The zoom lens of the present embodiment may satisfy condition expression (1) below:

1.63≤nd3f≤1.94 (1)

where,

nd3f represents a refractive index of the first positive lens disposed closest to the object side in the third lens group at a d line.

Condition expression (1) indicates a condition on a refractive index of a glass material used as the first positive lens.

An on-axis luminous flux is thickest at a position closest to the object side in the third lens group. Thus, spherical aberration and coma aberration are likely to be generated at the first positive lens.

When an upper limit value of condition expression (1) is exceeded, the refractive index of a glass material used as the first positive lens is too high. Typically, a glass material is more dispersive as the glass material has a higher refractive index. Thus, when the refractive index of a glass material used as the first positive lens is too high, axial chromatic aberration is largely generated at the first positive lens.

In this case, it is difficult to correct axial chromatic aberration at the third lens group. The number of lenses needs to be increased to correct axial chromatic aberration. However, the total length of the optical system increases as the number of lenses increases.

The zoom lens of the present embodiment may satisfy condition expression (2) below:

−0.39≤(1/f3b)/(1/f3)≤0.20 (2)

where,

f3b represents a focal length of the cemented lens disposed closest to the image side in the third lens group, and

f3 represents a focal length of the third lens group.

Condition expression (2) indicates a relation between refractive power of the cemented lens and refractive power of the whole third lens group.

When condition expression (2) has a positive value, the cemented lens has positive refractive power. In this case, the positive refractive power of the third lens group is distributed to the first positive lens, the second positive lens, and the cemented lens disposed sequentially from the object side in the third lens group. When a value of the condition expression (2) has a negative value, the cemented lens has negative refractive power. In this case, the positive refractive power of the third lens group is distributed to the first positive lens and the second positive lens.

When an upper limit value of condition expression (2) is exceeded, the positive refractive power of the cemented lens is too large. In other words, positive refractive power of the first positive lens and positive refractive power of the second positive lens both decrease.

Since the refractive powers of the two positive lenses decrease, the light beam height at the cemented surface increases. In this case, high-order aberration is generated. As a result, it is difficult to favorably correct coma aberration at the third lens group.

When a lower limit value of condition expression (2) is fallen below, the negative refractive power of the cemented lens is too large. In this case, the refractive powers of the two positive lenses need to be increased to obtain appropriate positive refractive power for the third lens group. However, aberration is largely generated through the two positive lenses when the refractive powers of the two positive lenses are increased.

As described above, spherical aberration and coma aberration are generated through the first positive lens. Spherical aberration and coma aberration are largely generated when the refractive power of the first positive lens is increased.

When condition expressions (1) and (2) are satisfied, generation of spherical aberration, generation of coma aberration, and generation of axial chromatic aberration can be suppressed.

The zoom lens of the present embodiment may satisfy condition expression (3) below:

41≤νd3bp−νd3bn≤65 (3)

where,

νd3bp represents a maximum Abbe number among Abbe numbers of the positive lens of the cemented lens disposed in the third lens group with respect to the d line, and

νd3bn represents a maximum Abbe number among Abbe numbers of the negative lens of the cemented lens with respect to the d line.

When condition expression (3) is satisfied, a glass material suitable for correction of chromatic aberration can be used as the cemented lens. As a result, it is possible to excellently correct chromatic aberration at the cemented lens.

The zoom lens of the present embodiment may satisfy condition expression (4) below:

0.59≤|f4|/|f5|≤0.91 (4)

where,

f4 represents a focal length of the fourth lens group, and

f5 represents a focal length of the fifth lens group.

Condition expression (4) indicates a relation between size of the focal length of the fourth lens group and size of the focal length of the fifth lens group.

The fourth lens group is a focus lens group. Focus sensitivity is determined by refractive power of the focus lens group and refractive power of a predetermined lens group. The predetermined lens group includes all lenses positioned on the image side of the focus lens group.

The fifth lens group is positioned on the image side of the fourth lens group. In this case, the fifth lens group corresponds to the predetermined lens group, and thus, focus sensitivity is determined by the refractive power of the fourth lens group and the refractive power of the fifth lens group. Condition expression (4) can be regarded as a condition expression related to appropriate focus sensitivity.

When an upper limit value of condition expression (4) is exceeded, the refractive power of the fourth lens group is too large. Thus, a change amount of aberration at focusing increases.

When a lower limit value of condition expression (4) is fallen below, the refractive power of the fourth lens group is too small. In this case, a moving amount of the fourth lens group at focusing is large. Thus, it is difficult to swiftly focus on an object.

The zoom lens of the present embodiment may satisfy condition expression (5) below:

0.17≤|f2|/ft≤0.39 (5)

where,

f2 represents a focal length of the second lens group, and

ft represents the focal length of the whole system of the zoom lens at the telephoto end.

When an upper limit value of condition expression (5) is exceeded, the refractive power of the second lens group is too small. As described above, the second lens group can have a magnification-varying function. When the refractive power of the second lens group is too small, the second lens group cannot provide a large magnification-varying effect. Thus, it is difficult to obtain a large magnification ratio.

When a lower limit value of condition expression (5) is fallen below, the refractive power of the second lens group is too large. In this case, the generation amount of various aberrations at the second lens group increases.

The zoom lens of the present embodiment may satisfy condition expression (6) below:

1.00≤d23w/fw≤1.94 (6)

where,

d23w represents an air interval between the second lens group and the third lens group at the wide-angle end, and

fw represents a focal length of the whole system of the zoom lens at the wide-angle end.

Condition expression (6) indicates a ratio of the air interval between the second lens group and the third lens group at the wide-angle end relative to the focal length at the wide-angle end. As described above, the second lens group and the third lens group can have a main magnification-varying function. Thus, the magnification ratio is mainly determined by the second lens group and the third lens group.

In this case, the magnification ratio is determined by the focal length of the second lens group, a moving amount of the second lens group, the focal length of the third lens group, and a moving amount of the third lens group.

When a lower limit value of condition expression (6) is fallen below, the air interval between the second lens group and the third lens group at the wide-angle end is too small. In this case, the focal length of the second lens group and the focal length of the third lens group need to be shortened to obtain a desired magnification ratio.

However, when the focal length of the second lens group and the focal length of the third lens group are shortened, the generation amount of various aberrations, for example, a generation amount of spherical aberration at the telephoto end increases at each of the second lens group and the third lens group.

When an upper limit value of condition expression (6) is exceeded, the air interval between the second lens group and the third lens group at the wide-angle end is too large. Thus, it is difficult to shorten the total length of the optical system at the wide-angle end.

The zoom lens of the present embodiment may satisfy condition expression (7) below:

1.24≤|f3|/|f2|≤1.48 (7)

where,

f2 represents the focal length of the second lens group, and

f3 represents the focal length of the third lens group.

Condition expression (7) indicates a ratio of a magnitude of the focal length of the second lens group relative to a magnitude of the focal length of the third lens group.

When an upper limit value of condition expression (7) is exceeded, the refractive power of the third lens group is too small or the refractive power of the second lens group is too large.

As described above, the second lens group and the third lens group can be moved at zooming. When the refractive power of the third lens group is too small, the moving amount of the third lens group is large. Thus, it is difficult to shorten the total length of the optical system at the telephoto end. When the refractive power of the second lens group is too large, the generation amount of spherical aberration at the telephoto end increases at the second lens group.

When a lower limit value of condition expression (7) is fallen below, the refractive power of the third lens group is too large or the refractive power of the second lens group is too small.

When the refractive power of the third lens group is too large, the generation amount of spherical aberration at the telephoto end increases at the third lens group.

When the refractive power of the second lens group is too small, the moving amount of the second lens group is large. Thus, it is difficult to shorten the total length of the optical system at the wide-angle end.

The zoom lens of the present embodiment may satisfy condition expression (8) below:

1.63≤nd3o≤1.94 (8)

where,

nd3o represents a refractive index of the positive lens disposed closest to the object side in the third lens group at the d line.

In the third lens group, a positive lens (hereinafter referred to as a “predetermined positive lens”) is positioned closest to the object side. Condition expression (8) indicates a condition on a refractive index of a glass material used as the predetermined positive lens.

An on-axis luminous flux is thickest at a position closest to the object side in the third lens group. Thus, spherical aberration and coma aberration are likely to be generated at the predetermined positive lens.

When a lower limit value of condition expression (8) is fallen below, the predetermined positive lens cannot have appropriate refractive power. Thus, generation of spherical aberration cannot be effectively suppressed.

When an upper limit value of condition expression (8) is exceeded, the refractive index of a glass material used as the predetermined positive lens is too high. Typically, a glass material is more dispersive as the glass material has a higher refractive index. Thus, when the refractive index of a glass material used as the predetermined positive lens is too high, axial chromatic aberration is largely generated at the predetermined positive lens.

In this case, it is difficult to correct axial chromatic aberration at the third lens group. The number of lenses needs to be increased to correct axial chromatic aberration. However, the total length of the optical system increases as the number of lenses increases.

The zoom lens of the present embodiment may satisfy condition expression (9) below:

5.00≤|f1|/|f2|≤8.74 (9)

where,

f1 represents a focal length of the first lens group, and

f2 represents the focal length of the second lens group.

Condition expression (9) indicates a ratio of a magnitude of the focal length of the first lens group relative to the magnitude of the focal length of the second lens group.

When an upper limit value of condition expression (9) is exceeded, the refractive power of the first lens group is too small or the refractive power of the second lens group is too large.

As described above, in the common optical system, the interval between each pair of adjacent lens groups changes at zooming. Thus, the first lens group can be moved at zooming. When the refractive power of the first lens group is too small, a moving amount of the first lens group is large. Thus, it is difficult to shorten the total length of the optical system at the telephoto end. When the refractive power of the second lens group is too large, the generation amount of spherical aberration at the telephoto end increases at the second lens group.

When a lower limit value of condition expression (9) is fallen below, the refractive power of the first lens group is too large or the refractive power of the second lens group is too small.

When the refractive power of the first lens group is too large, the generation amount of various aberrations, for example, a generation amount of coma aberration increases at the first lens group. When the refractive power of the second lens group is too small, the moving amount of the second lens group is large. Thus, it is difficult to shorten the total length of the optical system at the wide-angle end.

The zoom lens of the present embodiment may satisfy condition expression (10) below:

1.73≤|f1|/ft≤2.34 (10)

where,

f1 represents the focal length of the first lens group, and

ft represents the focal length of the whole system of the zoom lens at the telephoto end.

Condition expression (10) indicates a ratio of the focal length of the first lens group relative to the focal length of the whole system of the zoom lens at the telephoto end.

When a lower limit value of condition expression (10) is fallen below, the refractive power of the first lens group is too large. In this case, the generation amount of various aberrations increases at the first lens group.

When an upper limit value of condition expression (10) is exceeded, the refractive power of the first lens group is too small. As described above, the first lens group can be moved at zooming. When the refractive power of the first lens group is too small, the moving amount of the first lens group is large. Thus, it is difficult to shorten the total length of the optical system.

The zoom lens of the present embodiment may satisfy condition expression (11) below:

0.08≤|nd11−nd12|≤0.17 (11)

where,

nd11 represents a refractive index of the object-side lens positioned closest to the object side among lenses configuring the cemented lens disposed in the first lens group at the d line, and

nd12 represents a refractive index of the image-side lens positioned closest to the image side among lenses configuring the cemented lens disposed in the first lens group at the d line.

Condition expression (11) indicates a relation between the refractive index of the object-side lens at the d line and the refractive index of the image-side lens at the d line.

Typically, dispersion increases as a refractive index increases, and thus it is impossible to have sufficient dispersion difference between the object-side lens and the image-side lens when a lower limit value of condition expression (11) is fallen below. Accordingly, it is difficult to suppress generation of chromatic aberration.

When an upper limit value of condition expression (11) is exceeded, it is difficult to suppress generation of a curvature of field at the first lens group.

The zoom lens of the present embodiment may satisfy condition expression (12) below:

0.35≤|f3|/ft≤0.45 (12)

where,

f3 represents the focal length of the third lens group, and

ft represents the focal length of the whole system of the zoom lens at the telephoto end.

Condition expression (12) indicates a ratio of the focal length of the third lens group relative to the focal length of the whole system of the zoom lens at the telephoto end.

When an upper limit value of condition expression (12) is exceeded, the refractive power of the third lens group is too small. As described above, the third lens group can be moved at zooming. When the refractive power of the third lens group is too small, the moving amount of the third lens group is large. Thus, it is difficult to shorten the total length of the optical system at the telephoto end.

When a lower limit value of condition expression (12) is fallen below, the refractive power of the third lens group is too large. When the refractive power of the third lens group is too large, the generation amount of spherical aberration at the telephoto end increases at the third lens group.

Not all above-described configurations and condition expressions do not necessarily need to be satisfied. Any preferable configuration and any preferable condition expression may be selected from among the above-described configurations and condition expressions. Zoom lenses of various embodiments can be achieved by combining the common optical system with the configuration and condition expression thus selected.

The zoom lens of the first embodiment, the zoom lens of the second embodiment, a zoom lens of a third embodiment, a zoom lens of a fourth embodiment, and a zoom lens of a fifth embodiment will be described below.

The zoom lens of the first embodiment includes the common optical system. In addition, in the zoom lens of the first embodiment, the third lens group includes, sequentially from the object side, a first positive lens, a second positive lens, and a cemented lens, the first positive lens and the second positive lens are single lenses, the cemented lens includes a negative lens and a positive lens, and the zoom lens satisfies condition expressions (1) and (2) below:

1.63≤nd3f≤1.94 (1)

−0.39≤(1/f3b)/(1/f3)≤0.20 (2)

where,

nd3f represents a refractive index of the first positive lens disposed closest to the object side in the third lens group at the d line,

f3b represents a focal length of the cemented lens disposed closest to the image side in the third lens group, and

f3 represents the focal length of the third lens group.

The zoom lens of the first embodiment preferably includes a brightness aperture between the surface of the second lens group on the image side and the surface of the third lens group on the object side.

The zoom lens of the first embodiment preferably satisfies condition expression (3) below:

41≤νd3bp−νd3bn≤65 (3)

where,

νd3bp represents a maximum Abbe number among Abbe numbers of the positive lens of the cemented lens disposed in the third lens group with respect to the d line, and

νd3bn represents a maximum Abbe number among Abbe numbers of the negative lens of the cemented lens with respect to the d line.

The zoom lens of the second embodiment includes the common optical system. In addition, in the zoom lens of the second embodiment, the second lens group includes three or more negative lenses, the fourth lens group includes one single lens, the fifth lens group includes one single lens, the fourth lens group moves along the optical axis at focusing, and the zoom lens satisfies condition expression (4) below:

0.59≤|f4|/|f5|≤0.91 (4)

where,

f4 represents the focal length of the fourth lens group, and

f5 represents the focal length of the fifth lens group.

In the zoom lens of the second embodiment, the second lens group preferably includes, sequentially from the object side, a negative lens, a negative lens, a positive lens, and a negative lens.

The zoom lens of the second embodiment preferably satisfies condition expression (5) below:

0.17≤|f2|/ft≤0.39 (5)

where,

f2 represents the focal length of the second lens group, and

ft represents the focal length of the whole system of the zoom lens at the telephoto end.

The zoom lens of the third embodiment includes the common optical system. In addition, in the zoom lens of the third embodiment, the third lens group includes a positive lens disposed closest to the object side, and the zoom lens satisfies condition expressions (6), (7), and (8) below:

1.00≤d23w/fw≤1.94 (6)

1.24≤|f3|/|f2|≤1.48 (7)

1.63≤nd3o≤1.94 (8)

where,

d23w represents the air interval between the second lens group and the third lens group at the wide-angle end,

fw represents the focal length of the whole system of the zoom lens at the wide-angle end,

f2 represents the focal length of the second lens group,

f3 represents the focal length of the third lens group, and

nd3o represents a refractive index of the positive lens disposed closest to the object side in the third lens group at the d line.

The zoom lens of the fourth embodiment includes the common optical system. In addition, in the zoom lens of the fourth embodiment, the third lens group includes a positive lens disposed closest to the object side, and the zoom lens satisfies condition expressions (7), (8), and (9) below:

1.24≤|f3|/|f2|≤1.48 (7)

1.63≤nd3o≤1.94 (8)

−8.74≤f1/f2≤−5.00 (9)

where,

f1 represents the focal length of the first lens group,

f2 represents the focal length of the second lens group,

f3 represents the focal length of the third lens group, and

nd3o represents a refractive index of the positive lens disposed closest to the object side in the third lens group at the d line.

The zoom lens of the fifth embodiment includes the common optical system. In addition, in the zoom lens of the fifth embodiment, the first lens group is one cemented lens including a negative lens and a positive lens, the cemented lens includes an object-side lens positioned closest to the object side and an image-side lens positioned closest to the image side, and the zoom lens satisfies condition expressions (10) and (11) below:

1.73≤|f1|/ft≤2.34 (10)

0.08≤|nd11−nd12|≤0.17 (11)

where,

f1 represents the focal length of the first lens group,

ft represents the focal length of the whole system of the zoom lens at the telephoto end,

nd11 represents a refractive index of the object-side lens positioned closest to the object side among lenses configuring the cemented lens disposed in the first lens group at the d line, and

nd12 represents a refractive index of the image-side lens positioned closest to the image side among lenses configuring the cemented lens disposed in the first lens group at the d line.

In the zoom lens of the fifth embodiment, the object-side lens is preferably the negative lens of the cemented lens, and the image-side lens is preferably the positive lens of the cemented lens.

An image pickup apparatus of the present embodiment includes an optical system and an image pickup device disposed on an image plane, the image pickup device includes an image pickup surface and converts an image formed on the image pickup surface through the optical system into an electric signal, and the optical system is an above-described zoom lens.

According to the image pickup apparatus of the present embodiment, it is possible to acquire a clear image with small brightness change at zooming.

The lower or upper limit value of each condition expression may be changed as described below. Such change is preferable because an effect of each condition expression can be further reliably obtained.

Condition expression (1) may be as follows:

The lower limit value is preferably 1.65 or 1.68.
The upper limit value is preferably 1.92 or 1.89.

Condition expression (2) may be as follows:

The lower limit value is preferably −0.33 or −0.27.

Condition expression (3) may be as follows:

The lower limit value is preferably 43 or 46.
The upper limit value is preferably 63 or 60.

Condition expression (4) may be as follows:

The lower limit value is preferably 0.60.
The upper limit value is preferably 0.86 or 0.81.

Condition expression (5) may be as follows:

The lower limit value is preferably 0.20 or 0.22.
The upper limit value is preferably 0.37 or 0.34.

Condition expression (6) may be as follows:

The lower limit value is preferably 1.21 or 1.38.
The upper limit value is preferably 1.92 or 1.90.

Condition expression (7) may be as follows:

The lower limit value is preferably 1.25.
The upper limit value is preferably 1.46 or 1.44.

Condition expression (8) may be as follows:

The lower limit value is preferably 1.65 or 1.68.
The upper limit value is preferably 1.92 or 1.89.

Condition expression (9) may be as follows:

The lower limit value is preferably 5.38 or 5.76.
The upper limit value is preferably 8.72 or 8.69.

Condition expression (10) may be as follows:

The lower limit value is preferably 1.80 or 1.85.
The upper limit value is preferably 2.30 or 2.25.

Condition expression (11) may be as follows:

The upper limit value is preferably 0.16.

Condition expression (12) may be as follows:

The lower limit value is preferably 0.37.
The upper limit value is preferably 0.43.

Examples of zoom lenses will be described below in detail with reference to the accompanying drawings. Note that the present invention is not limited by the examples.

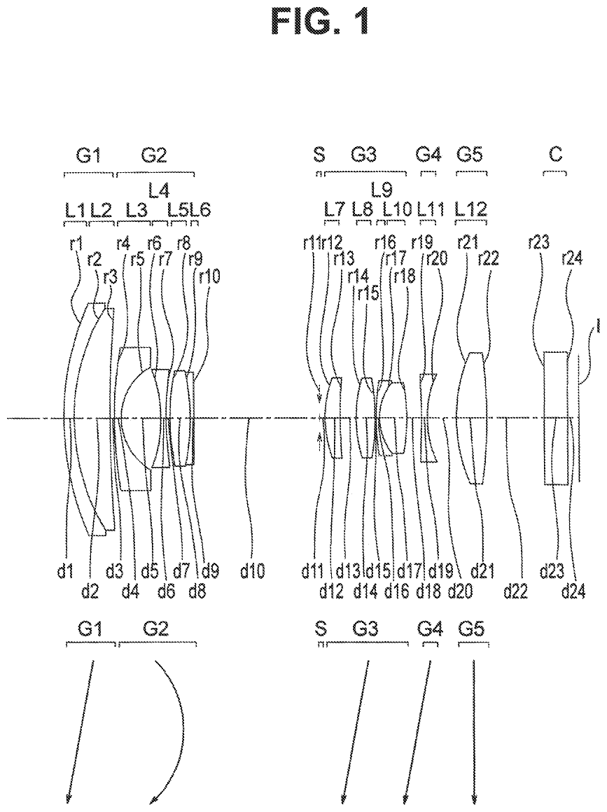

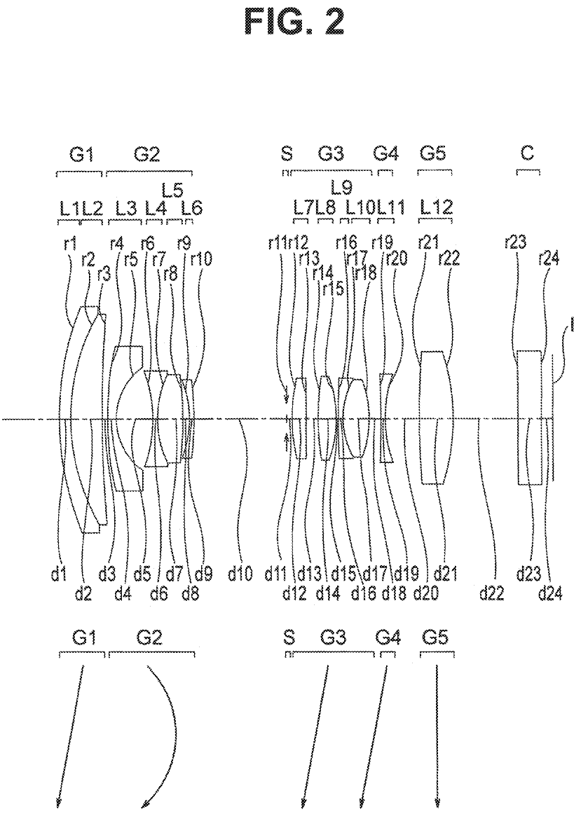

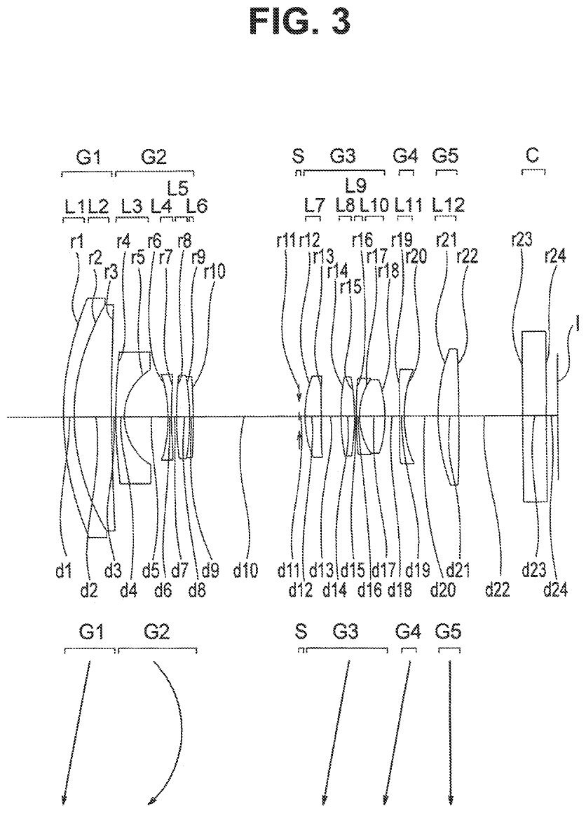

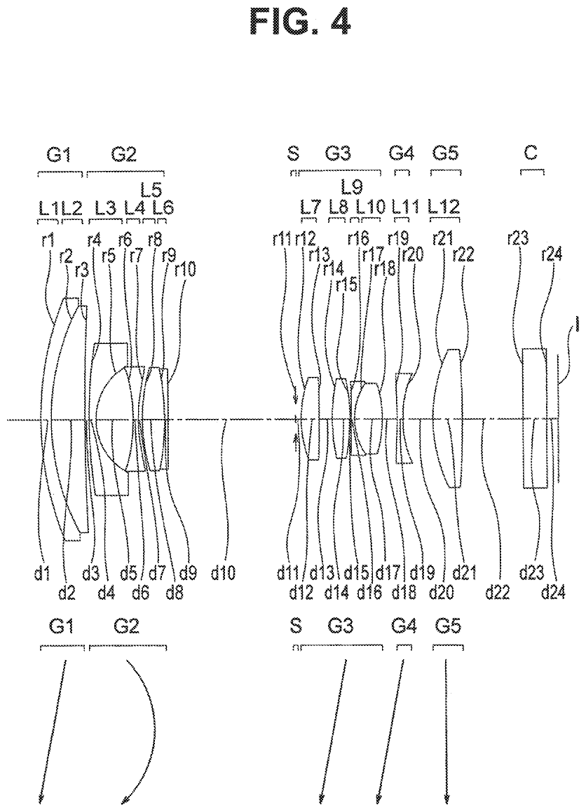

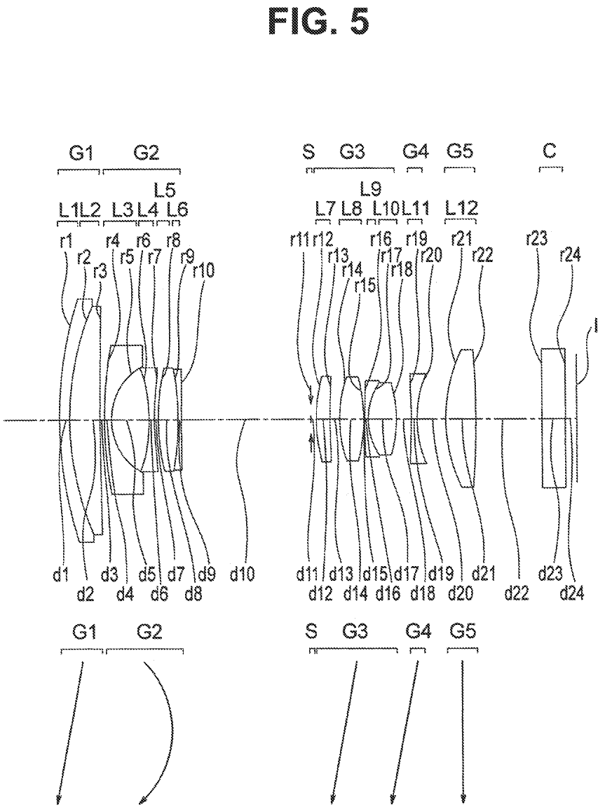

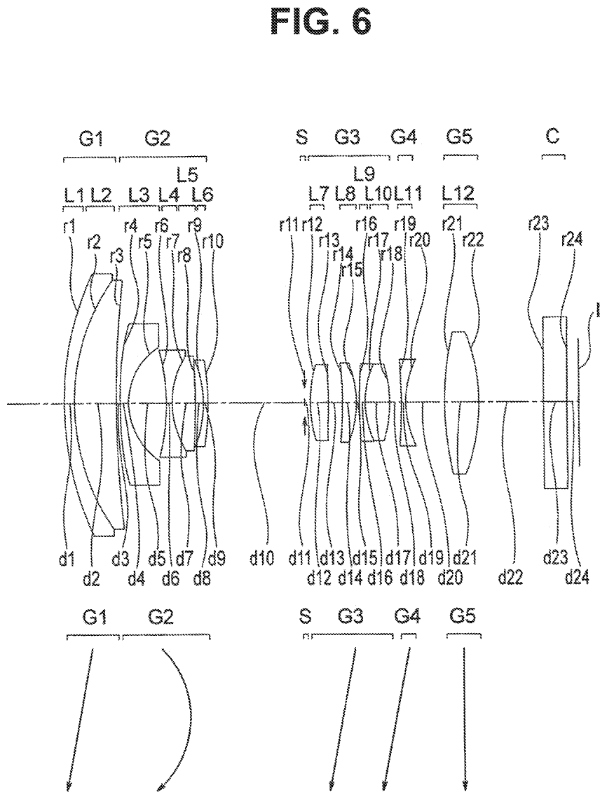

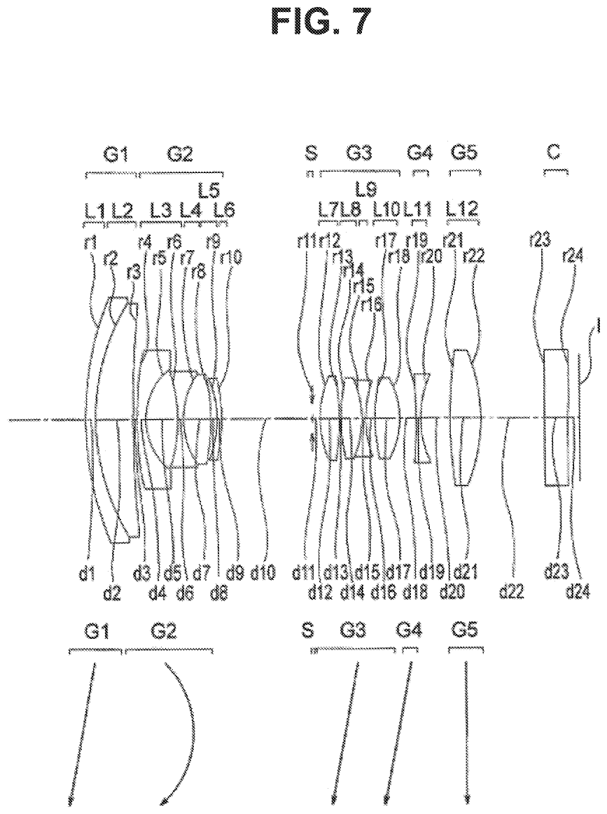

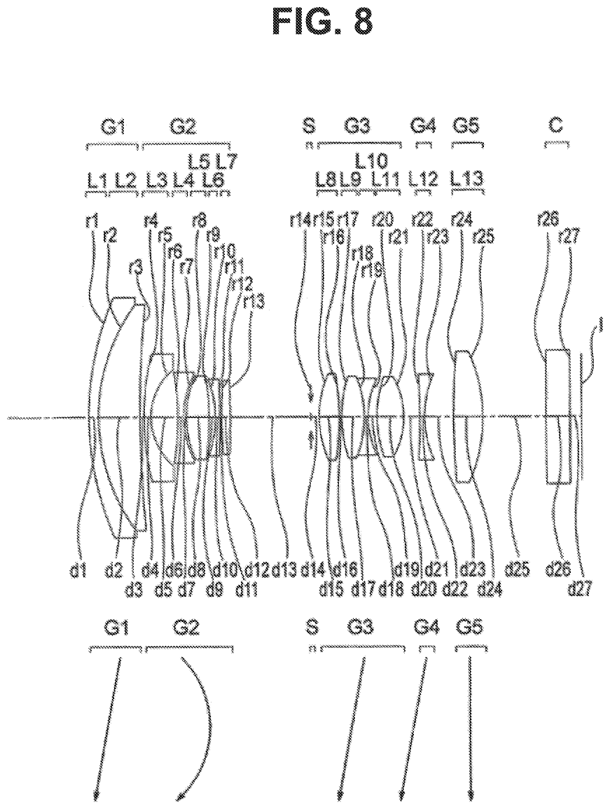

A lens cross-sectional view of each example will be described. The lens cross-sectional view is a lens cross-sectional view at focusing on an object at infinity. FIG. 1 to FIG. 8 are lens cross-sectional views at the wide-angle end.

The first lens group is denoted by G1, the second lens group is denoted by G2, the third lens group is denoted by G3, the fourth lens group is denoted by G4, the fifth lens group is denoted by G5, the brightness aperture is denoted by S, and the image plane (image pickup surface) is denoted by I. In addition, a cover glass C of the image pickup device is disposed between the fifth lens group G5 and the image plane I.

An aberration diagram of each example will be described. The aberration diagram is an aberration diagram at focusing on an object at infinity.

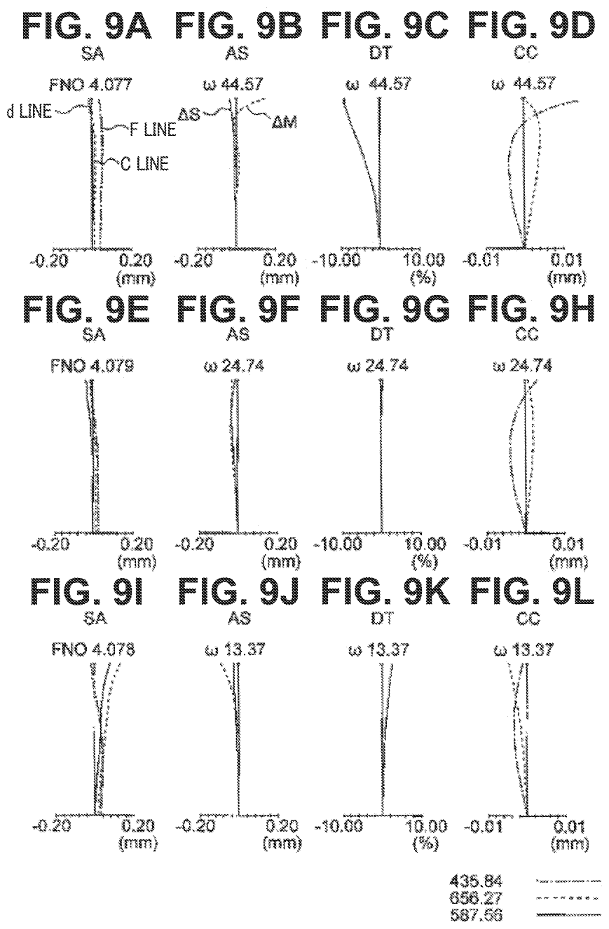

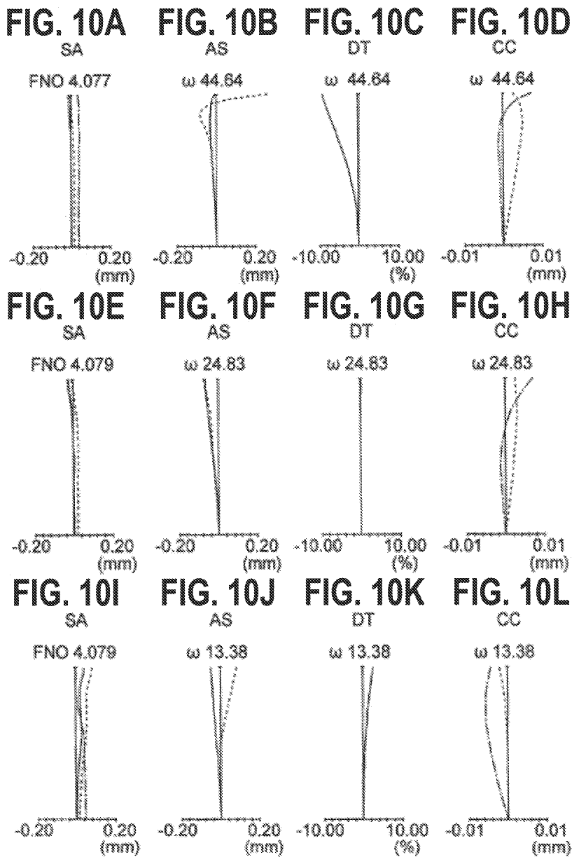

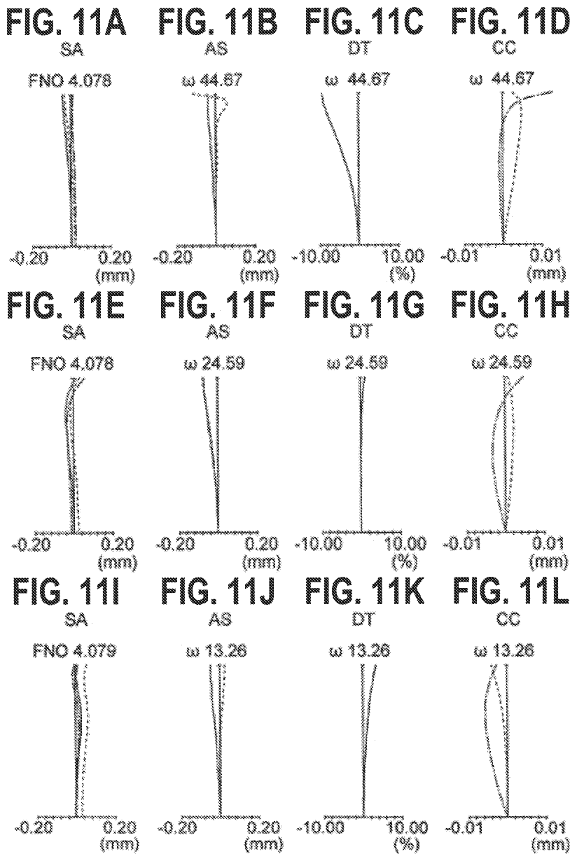

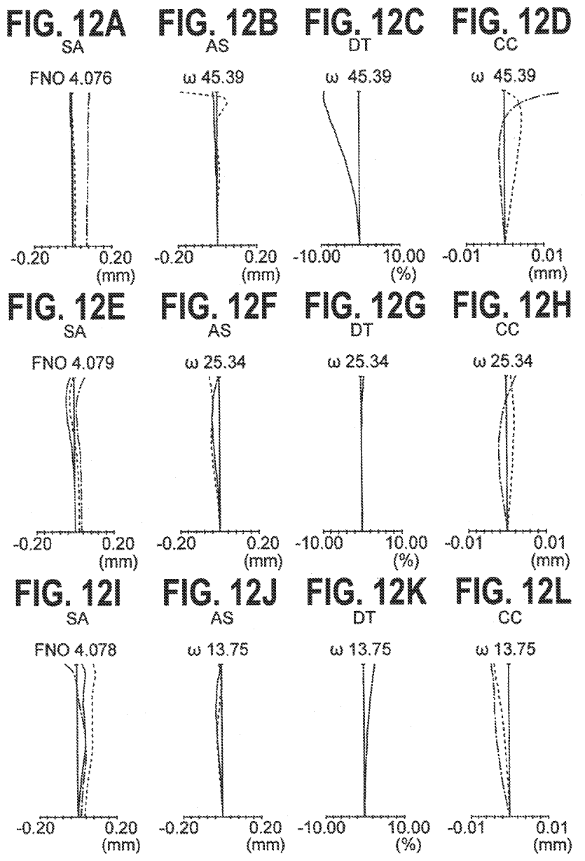

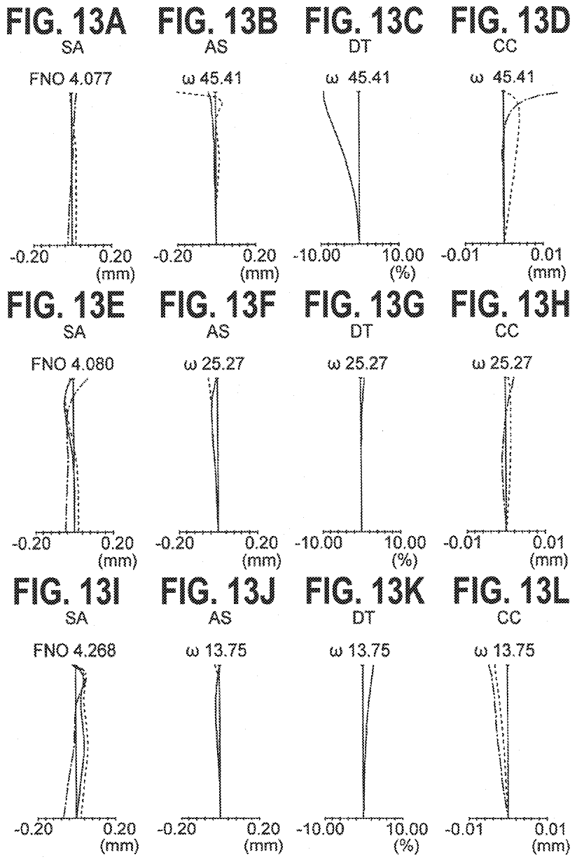

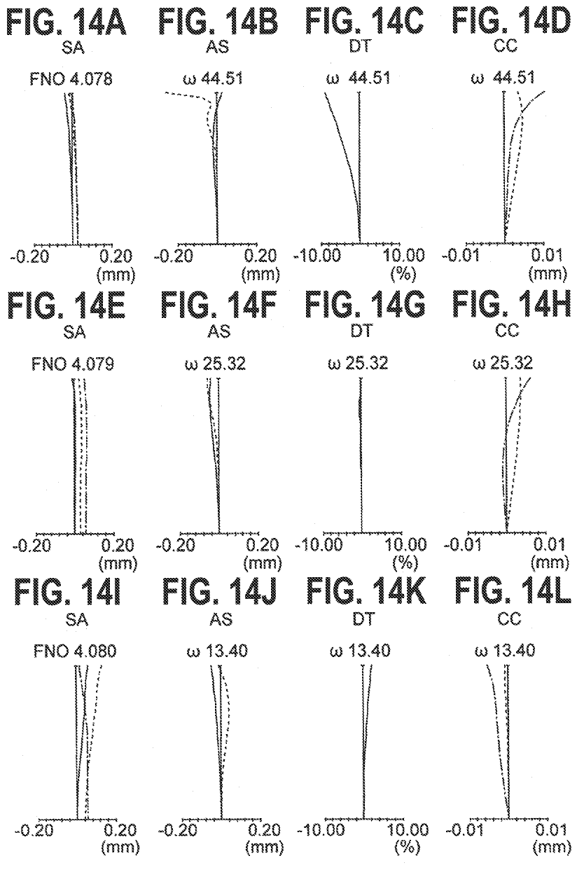

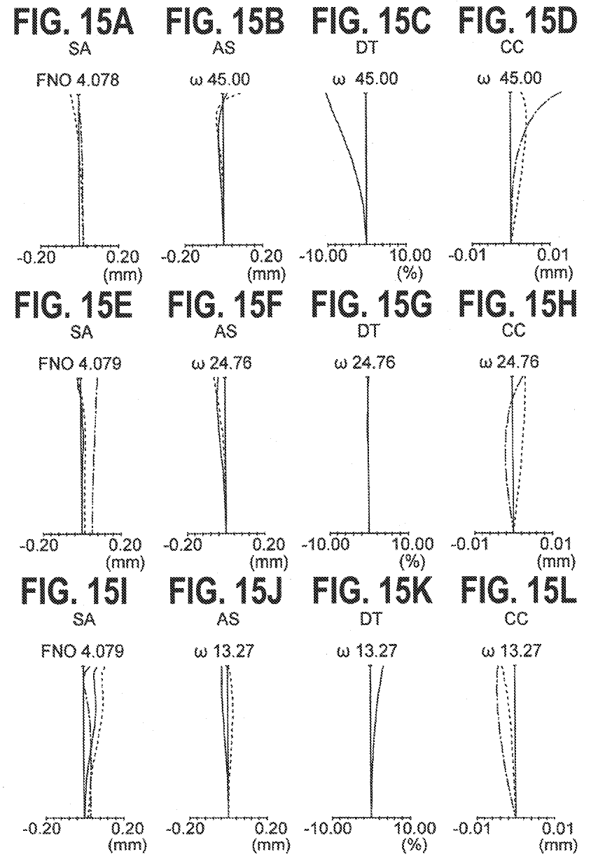

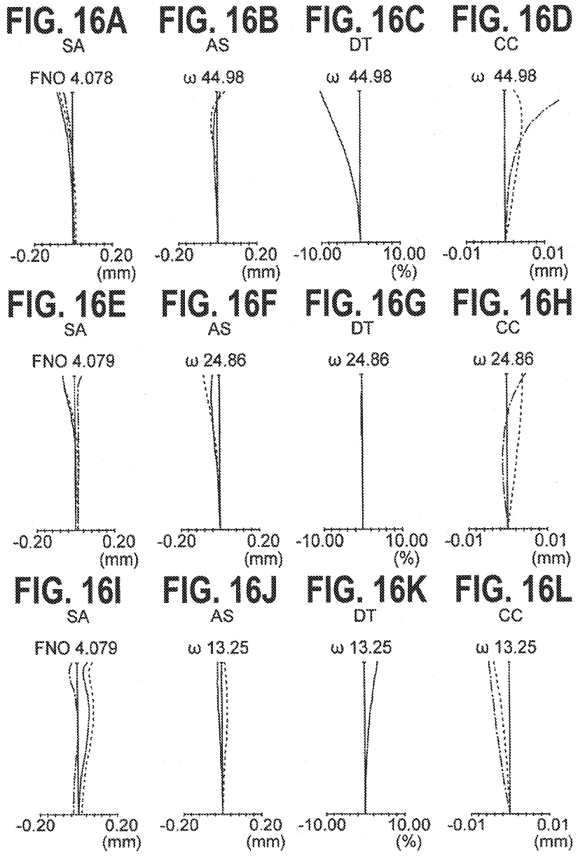

FIGS. 9A, 10A, 11A, 12A, 13A, 14A, 15A, and 16A each illustrate spherical aberration (SA) at the wide-angle end.

FIGS. 9B, 10B, 11B, 12B, 13B, 14B, 15B, and 16B each illustrate astigmatism (AS) at the wide-angle end.
FIGS. 9C, 10C, 11C, 12C, 13C, 14C, 15C, and 16C each illustrate distortion (DT) at the wide-angle end.
FIGS. 9D, 10D, 11D, 12D, 13D, 14D, 15D, and 16D each illustrate chromatic aberration of magnification (CC) at the wide-angle end.

FIGS. 9E, 10E, 11E, 12E, 13E, 14E, 15E, and 16E each illustrate spherical aberration (SA) in an intermediate focal length state.

FIGS. 9F, 10F, 11F, 12F, 13F, 14F, 15F, and 16F each illustrate astigmatism (AS) in the intermediate focal length state.

FIGS. 9G, 10G, 11G, 12G, 13G, 14G, 15G, and 16G each illustrate distortion (DT) in the intermediate focal length state.

FIGS. 9H, 10H, 11H, 12H, 13H, 14H, 15H, and 16H each illustrate chromatic aberration of magnification (CC) in the intermediate focal length state.

FIGS. 9I, 10I, 11I, 12I, 13I, 14I, 15I, and 16I each illustrate spherical aberration (SA) at the telephoto end.

FIGS. 9J, 10J, 11J, 12J, 13J, 14J, 15J, and 16J each illustrate astigmatism (AS) at the telephoto end.
FIGS. 9K, 10K, 11K, 12K, 13K, 14K, 15K, and 16K each illustrate distortion (DT) at the telephoto end.
FIGS. 9L, 10L, 11L, 12L, 13L, 14L, 15L, and 16L each illustrate chromatic aberration of magnification (CC) at the telephoto end.

A zoom lens of Example 1 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a negative meniscus lens L6 having a convex surface on the image side. The biconvex positive lens L5 and the negative meniscus lens L6 are cemented.

The third lens group G3 includes a positive meniscus lens L7 having a convex surface on the object side, a biconvex positive lens L8, a negative meniscus lens L9 having a convex surface on the object side, and a biconvex positive lens L10. The negative meniscus lens L9 and the biconvex positive lens L10 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from an infinity object point to a close-distance object point, the fourth lens group G4 moves toward the image side.

Aspherical surfaces are provided at six surfaces in total, namely, both surfaces of the biconcave negative lens L4, both surfaces of the positive meniscus lens L7, and both surfaces of the biconcave negative lens L11.

A zoom lens of Example 2 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a negative meniscus lens L6 having a convex surface on the image side. The biconcave negative lens L4 and the biconvex positive lens L5 are cemented.

The third lens group G3 includes a biconvex positive lens L7, a biconvex positive lens L8, a negative meniscus lens L9 having a convex surface on the object side, and a biconvex positive lens L10. The negative meniscus lens L9 and the biconvex positive lens L10 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from the infinity object point to the close-distance object point, the fourth lens group G4 moves toward the image side.

Aspherical surfaces are provided at six surfaces in total, namely, both surfaces of the negative meniscus lens L3, both surfaces of the biconvex positive lens L7, and both surfaces of the biconcave negative lens L11.

A zoom lens of Example 3 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a negative meniscus lens L6 having a convex surface on the image side. The biconvex positive lens L5 and the negative meniscus lens L6 are cemented.

The third lens group G3 includes a positive meniscus lens L7 having a convex surface on the object side, a biconvex positive lens L8, a negative meniscus lens L9 having a convex surface on the object side, and a biconvex positive lens L10. The negative meniscus lens L9 and the biconvex positive lens L10 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The adjacent second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from the infinity object point to the close-distance object point, the fourth lens group G4 moves toward the image side.

Aspherical surfaces are provided at six surfaces in total, namely, both surfaces of the biconcave negative lens L4, both surfaces of the positive meniscus lens L7, and both surfaces of the biconcave negative lens L11.

A zoom lens of Example 4 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a negative meniscus lens L6 having a convex surface on the image side. The biconvex positive lens L5 and the negative meniscus lens L6 are cemented.

The third lens group G3 includes a biconvex positive lens L7, a biconvex positive lens L8, a biconcave negative lens L9, and a biconvex positive lens L10. The biconcave negative lens L9 and the biconvex positive lens L10 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from the infinity object point to the close-distance object point, the fourth lens group G4 moves toward the image side.

Aspherical surfaces are provided at six surfaces in total, namely, both surfaces of the biconcave negative lens L4, both surfaces of the biconvex positive lens L7, and both surfaces of the biconcave negative lens L11.

A zoom lens of Example 5 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a biconcave negative lens L6. The biconvex positive lens L5 and the biconcave negative lens L6 are cemented.

The third lens group G3 includes a positive meniscus lens L7 having a convex surface on the object side, a biconvex positive lens L8, a negative meniscus lens L9 having a convex surface on the object side, and a biconvex positive lens L10. The negative meniscus lens L9 and the biconvex positive lens L10 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from the infinity object point to the close-distance object point, the fourth lens group G4 moves toward the image side.

Aspherical surfaces are provided at six surfaces in total, namely, both surfaces of the biconcave negative lens L4, both surfaces of the positive meniscus lens L7, and both surfaces of the biconcave negative lens L11.

A zoom lens of Example 6 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a negative meniscus lens L6 having a convex surface on the image side. The biconcave negative lens L4 and the biconvex positive lens L5 are cemented.

The third lens group G3 includes a biconvex positive lens L7, a positive meniscus lens L8 having a convex surface on the image side, a negative meniscus lens L9 having a convex surface on the object side, and a biconvex positive lens L10. The negative meniscus lens L9 and the biconvex positive lens L10 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from the infinity object point to the close-distance object point, the fourth lens group G4 moves toward the image side.

Aspherical surfaces are provided at six surfaces in total, namely, both surfaces of the negative meniscus lens L3, both surfaces of the biconvex positive lens L7, and both surfaces of the biconcave negative lens L11.

A zoom lens of Example 7 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a negative meniscus lens L6 having a convex surface on the image side. The biconcave negative lens L4 and the biconvex positive lens L5 are cemented.

The third lens group G3 includes a biconvex positive lens L7, a biconvex positive lens L8, a biconcave negative lens L9, and a biconvex positive lens L10. The biconvex positive lens L8 and the biconcave negative lens L9 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from the infinity object point to the close-distance object point, the fourth lens group G4 moves toward the image side.

Aspherical surfaces are provided at seven surfaces in total, namely, both surfaces of the negative meniscus lens L3, both surfaces of the biconvex positive lens L7, both surfaces of the biconvex positive lens L10, and a surface of the biconcave negative lens L11 on the image side.

A zoom lens of Example 8 includes, sequentially from the object side, the first lens group G1 having positive refractive power, the second lens group G2 having negative refractive power, the third lens group G3 having positive refractive power, the fourth lens group G4 having negative refractive power, and the fifth lens group G5 having positive refractive power.

The first lens group G1 includes a negative meniscus lens L1 having a convex surface on the object side and a positive meniscus lens L2 having a convex surface on the object side. The negative meniscus lens L1 and the positive meniscus lens L2 are cemented.

The second lens group G2 includes a negative meniscus lens L3 having a convex surface on the object side, a biconcave negative lens L4, a biconvex positive lens L5, and a negative meniscus lens L6 having a convex surface on the image side, and a biconvex positive lens L7.

The third lens group G3 includes a biconvex positive lens L8, a biconvex positive lens L9, a biconcave negative lens L10, and a biconvex positive lens L11. The biconcave negative lens L9 and the biconvex positive lens L10 are cemented.

The fourth lens group G4 includes a biconcave negative lens L11.

The fifth lens group G5 includes a biconvex positive lens L12.

The brightness aperture S is disposed between the second lens group G2 and the third lens group G3. The cover glass C is disposed on the image side of the fifth lens group G5.

At zooming from the wide-angle end to the telephoto end, the interval between each pair of adjacent lens groups changes. The first lens group G1 moves toward the object side. The second lens group G2 moves toward the image side and then moves toward the object side. The third lens group G3 moves toward the object side. The fourth lens group G4 moves toward the object side. The fifth lens group G5 is at rest.

At focusing, the fourth lens group G4 moves. At focusing from the infinity object point to the close-distance object point, the fourth lens group G4 moves toward the image side.

Aspherical surfaces are provided at seven surfaces in total, namely, both surfaces of the biconcave negative lens L4, both surfaces of the biconvex positive lens L8, both surfaces of the biconvex positive lens L11, and a surface of the biconcave negative lens L11 on the image side.

Numerical data of each above-described example is listed below. In surface data, r represents a curvature radius of each lens surface, d represents an interval between each of the lens surfaces, nd represents a refractive index of each lens at the d line, νd represents an Abbe number of each lens, and “*” represents an aspherical surface. An aperture is a brightness aperture.

In zoom data, WE represents the wide-angle end, ST1 represents an intermediate focal length state 1, ST2 represents an intermediate focal length state 2, ST3 represents an intermediate focal length state 3, and TE represents the telephoto end. The state ST1 is a state between WE and ST2, and the state ST3 is a state between ST2 and TE. In an actual case of magnification-varying from the wide-angle end to the telephoto end, the magnification-varying is performed in order of WE, ST1, ST2, ST3, and TE.

In addition, f represents the focal length of the whole system, FNO. represents an F number, w represents a half angle of view, BF represents back focus, and LTL represents the total length of the optical system. The back focus is expressed in an air-converted distance from a lens surface closest to the image side to the image plane. The total length is a sum of the back focus and a distance from a lens surface closest to the object side to the lens surface closest to the image side.

In group focal lengths, f1, f2, . . . represent focal lengths of respective lens groups.

An aspherical surface shape is expressed as an equation below where z represents a direction of the optical axis, y represents a direction orthogonal to the optical axis, k represents a conical coefficient, and A4, A6, A8, A10, A12, . . . represent aspherical surface coefficients.

z=(y²/r)/[1+{1−(1+k)(y/r)²}^{1/2}]+A4y⁴+A6y⁶+A8y⁸+A10y¹⁰+A12y¹²+ . . .

In the aspherical surface coefficient, “e-n” (n is an integer) means “10⁻ⁿ”. Note that these data symbols represent same in numerical data of examples to be described later.

### Numerical Example 1

Unit mm
Surface data

| Surface number | r | d | nd | νd |
|---|---|---|---|---|
| 1 | 47.853 | 1.80 | 1.92286 | 18.90 |
| 2 | 36.315 | 6.20 | 1.77250 | 49.60 |
| 3 | 236.613 | variable | | |
| 4 | 71.723 | 1.20 | 1.83481 | 42.74 |
| 5 | 10.124 | 6.86 | | |
| 6* | −27.202 | 0.90 | 1.58313 | 59.38 |
| 7* | 36.480 | 0.70 | | |
| 8 | 39.004 | 3.50 | 2.00100 | 29.13 |
| 9 | −39.004 | 0.60 | 1.71999 | 50.23 |
| 10 | −12728.053 | variable | | |
| 11 (aperture) | ∞ | 1.00 | | |
| 12* | 18.320 | 2.67 | 1.74320 | 49.34 |
| 13* | 100.000 | 2.80 | | |
| 14 | 22.469 | 3.29 | 1.49700 | 81.54 |
| 15 | −44.000 | 0.20 | | |
| 16 | 40.000 | 0.60 | 1.91082 | 35.25 |
| 17 | 9.444 | 4.72 | 1.49700 | 81.54 |
| 18 | −32.319 | variable | | |
| 19* | −64.316 | 1.00 | 1.53071 | 55.69 |
| 20* | 20.350 | variable | | |
| 21 | 28.000 | 5.23 | 1.51823 | 58.90 |
| 22 | −85.294 | 10.14 | | |
| 23 | ∞ | 4.11 | 1.51633 | 64.14 |
| 24 | ∞ | 2.00 | | |
| Image plane | ∞ | | | |

Aspherical data

Sixth surface
k = 0.000
A4 = −1.03051e−04, A6 = 2.10669e−06, A8 = −2.80389e−08,
A10 = 1.20443e−10
Seventh surface
k = 0.000
A4 = −1.37375e−04, A6 = 2.29620e−06, A8 = −3.34216e−08,
A10 = 1.73499e−10
Twelfth surface
k = 0.000
A4 = −1.04826e−05, A6 = 1.71953e−07, A8 = −4.29469e−09
Thirteenth surface
k = 0.000
A4 = 3.27632e−05, A6 = 2.08660e−07, A8 = −4.65262e−09
Nineteenth surface
k = 0.000
A4 = 9.83534e−05, A6 = −3.03476e−07
Twentieth surface
k = 0.000
A4 = 1.18832e−04, A6 = −8.06363e−07, A8 = 3.82351e−09,
A10 = −3.68592e−11

Zoom data

| | WE | ST2 | TE | ST1 | ST3 |
|---|---|---|---|---|---|
| f | 12.35 | 23.33 | 44.08 | 16.97 | 31.99 |
| FNO. | 4.08 | 4.08 | 4.08 | 4.08 | 4.08 |
| 2ω | 89.15 | 49.49 | 26.75 | 66.81 | 36.54 |
| BF (in air) | 14.85 | 14.85 | 14.85 | 14.85 | 14.85 |
| LTL (in air) | 88.55 | 91.26 | 107.65 | 88.93 | 96.81 |
| d3 | 0.76 | 10.01 | 24.20 | 5.21 | 15.70 |
| d10 | 22.02 | 8.68 | 2.40 | 14.62 | 4.48 |
| d18 | 2.59 | 7.29 | 10.21 | 4.64 | 9.78 |
| d20 | 5.05 | 7.16 | 12.71 | 6.35 | 8.72 |

Respective group focal lengths

| | | | | |
|---|---|---|---|---|
| f1 = 82.05 | f2 = −13.92 | f3 = 18.23 | f4 = −29.01 | f5 = 41.33 |

### Numerical Example 2

Unit mm
Surface data

| Surface number | r | d | nd | νd |
|---|---|---|---|---|
| 1 | 48.675 | 2.00 | 1.92286 | 20.88 |
| 2 | 34.672 | 5.54 | 1.77250 | 49.62 |
| 3 | 213.997 | variable | | |
| 4* | 67.652 | 1.50 | 1.85135 | 40.10 |
| 5* | 10.603 | 6.35 | | |
| 6 | −23.551 | 0.80 | 1.57099 | 50.80 |
| 7 | 17.571 | 4.30 | 2.00069 | 25.46 |
| 8 | −63.445 | 1.14 | | |
| 9 | −17.904 | 0.80 | 1.70154 | 41.24 |
| 10 | −54.833 | variable | | |
| 11 (aperture) | ∞ | 1.00 | | |
| 12* | 23.302 | 2.50 | 1.74320 | 49.34 |
| 13* | −1344.442 | 2.20 | | |
| 14 | 44.574 | 3.17 | 1.58913 | 61.14 |
| 15 | −20.569 | 0.38 | | |
| 16 | 303.923 | 0.80 | 1.95375 | 32.32 |
| 17 | 13.314 | 4.48 | 1.49700 | 81.54 |
| 18 | −18.455 | variable | | |
| 19* | −57.485 | 0.80 | 1.53071 | 55.69 |
| 20* | 31.341 | variable | | |
| 21 | 144.568 | 5.80 | 1.53172 | 48.84 |
| 22 | −35.851 | 11.22 | | |
| 23 | ∞ | 4.11 | 1.51633 | 64.14 |
| 24 | ∞ | 2.00 | | |
| Image plane | ∞ | | | |

Aspherical data

Fourth surface
k = 0.000
A4 = 1.38926e−05
Fifth surface
k = 0.000
A4 = −1.06526e−05, A6 = −1.78605e−08
Twelfth surface
k = 0.000
A4 = −1.61151e−05, A6 = −8.66055e−07, A8 = −5.93285e−09,
A10 =−9.51214e−11
Thirteenth surface
k = 0.000
A4 = 7.69391e−05, A6 = −7.71733e−07, A8 = −1.00146e−08,
A10 =−2.94704e−11
Nineteenth surface
k = 0.000
A4 = 2.983466−04, A6 = −7.03414e−06, A8 = 1.02737e−07,
A10 = −6.95497e−10
Twentieth surface
k = 0.000
A4 = 3.18486e−04, A6 = −7.00503e−06, A8 = 9.89137e−08,
A10 = −6.66197e−10, A12 = 2.03305e−13

Zoom data

| | WE | ST2 | TE | ST1 | ST3 |
|---|---|---|---|---|---|
| f | 12.35 | 23.33 | 44.09 | 16.99 | 32.00 |
| FNO. | 4.08 | 4.08 | 4.08 | 4.08 | 4.08 |
| 2ω | 89.29 | 49.65 | 26.76 | 66.99 | 36.56 |
| BF (in air) | 15.93 | 15.93 | 15.93 | 15.93 | 15.93 |
| LTL (in air) | 84.53 | 87.79 | 112.53 | 84.53 | 96.16 |
| d3 | 0.95 | 6.09 | 24.05 | 3.45 | 11.76 |
| d10 | 16.19 | 5.06 | 1.40 | 9.74 | 2.11 |
| d18 | 2.05 | 7.62 | 8.70 | 4.67 | 10.03 |
| d20 | 5.84 | 9.53 | 18.88 | 7.17 | 12.75 |

Respective group focal lengths

| | | | | |
|---|---|---|---|---|
| f1 = 88.21 | f2 = −12.05 | f3 = 16.59 | f4 =−38.10 | f5 = 54.64 |

### Numerical Example 3

Unit mm
Surface data

| Surface number | r | d | nd | νd |
|---|---|---|---|---|
| 1 | 51.394 | 1.80 | 1.92286 | 20.88 |
| 2 | 36.712 | 6.44 | 1.77250 | 49.62 |
| 3 | 389.014 | variable | | |
| 4 | 95.641 | 1.50 | 1.83481 | 42.74 |
| 5 | 9.563 | 7.58 | | |
| 6* | −24.917 | 0.60 | 1.51633 | 64.14 |
| 7* | 64.108 | 0.83 | | |
| 8 | 58.091 | 2.31 | 2.00069 | 25.46 |
| 9 | −41.178 | 0.60 | 1.83481 | 42.74 |
| 10 | −124.893 | variable | | |
| 11 (aperture) | ∞ | 1.00 | | |
| 12* | 18.532 | 2.85 | 1.74320 | 49.34 |
| 13* | 666.169 | 3.49 | | |
| 14 | 38.729 | 2.35 | 1.48749 | 70.23 |
| 15 | −39.376 | 0.30 | | |
| 16 | 73.256 | 0.60 | 1.95375 | 32.32 |
| 17 | 11.235 | 4.45 | 1.49700 | 81.54 |
| 18 | −19.479 | variable | | |
| 19* | −193.327 | 0.80 | 1.53071 | 55.69 |
| 20* | 23.672 | variable | | |
| 21 | 33.918 | 3.54 | 1.56384 | 60.67 |
| 22 | −308.199 | 11.12 | | |
| 23 | ∞ | 4.11 | 1.51633 | 64.14 |
| 24 | ∞ | 2.00 | | |
| Image plane | ∞ | | | |

Aspherical data

Sixth surface
k = 0.000
A4 = 5.85038e−05, A6 = −1.70217e−06, A8 = 8.78951e−09,
A10 = −1.05972e−10
Seventh surface
k = 0.000
A4 = −3.35231e−06, A6 = −1.73448e−06, A8 = 1,40654e−09,
A10 = 3.44839e−12
Twelfth surface
k = 0.000
A4 = −2.70897e−06, A6 = 3.91910e−07, A8 = −8.11002e−09,
A10 = 5.89075e−12
Thirteenth surface
k = 0.000
A4 = 5.29731e−05, A6 = 4.30284e−07, A8 = −7.77641e−09
Nineteenth surface
k = 0.000
A4 = 2.25649e−05, A6 = 4.90102e−07, A8 = 4.86485e−09
A10 = −2.45268e−11
Twentieth surface
k = 0.000
A4 = 3.16042e−05, A6 = 4.05711e−07, A8 = 1.04005e−09

Zoom data

| | WE | ST2 | TE | ST1 | ST3 |
|---|---|---|---|---|---|
| f | 12.35 | 23.33 | 44.09 | 16.98 | 32.07 |
| FNO. | 4.08 | 4.08 | 4.08 | 4.08 | 4.08 |
| 2ω | 89.35 | 49.18 | 26.53 | 66.58 | 36.28 |
| BF (in air) | 15.82 | 15.82 | 15.82 | 15.82 | 15.82 |
| LTL (in air) | 84.51 | 90.20 | 109.74 | 85.67 | 97.11 |
| d3 | 0.76 | 10.63 | 24.99 | 5.00 | 16.38 |
| d10 | 18.47 | 6.60 | 1.30 | 11.61 | 2.85 |
| d18 | 2.58 | 7.24 | 8.73 | 4.78 | 9.48 |
| d20 | 5.84 | 8.87 | 17.87 | 7.43 | 11.54 |

Respective group focal lengths

| | | | | |
|---|---|---|---|---|
| f1 = 82.80 | f2 = −13.48 | f3 = 18.57 | f4 = −39.69 | f5 = 54.39 |

### Numerical Example 4

Unit mm
Surface data

| Surface number | r | d | nd | νd |
|---|---|---|---|---|
| 1 | 52.350 | 1.80 | 1.92286 | 18.90 |
| 2 | 39.293 | 5.86 | 1.77250 | 49.60 |
| 3 | 342.150 | variable | | |
| 4 | 80.504 | 1.20 | 1.83481 | 42.74 |
| 5 | 9.969 | 6.52 | | |
| 6* | −31.007 | 0.90 | 1.58313 | 59.38 |
| 7* | 24.553 | 0.70 | | |
| 8 | 28.785 | 3.85 | 2.00100 | 29.13 |
| 9 | −42.644 | 0.60 | 1.83481 | 42.74 |
| 10 | −661.491 | variable | | |
| 11 (aperture) | ∞ | 1.00 | | |
| 12* | 17.996 | 3.16 | 1.69350 | 53.21 |
| 13* | −146.191 | 2.30 | | |
| 14 | 30.837 | 3.07 | 1.51633 | 64.14 |
| 15 | −33.061 | 0.20 | | |
| 16 | −615.633 | 0.60 | 1.91082 | 35.25 |
| 17 | 10.528 | 4.77 | 1.49700 | 81.54 |
| 18 | −19.356 | variable | | |
| 19* | −71.255 | 1.00 | 1.53071 | 55.69 |
| 20* | 19.844 | variable | | |
| 21 | 25.676 | 5.11 | 1.51742 | 52.43 |
| 22 | −157.396 | 10.58 | | |
| 23 | ∞ | 4.11 | 1.51633 | 64.14 |
| 24 | ∞ | 2.00 | | |
| Image plane | ∞ | | | |

Aspherical data

Sixth surface
k = 0.000
A4 = −3.99535e−05, A6 = 9.87239e−07, A8 = −1.71186e−08,
A10 = 6.71988e−11
Seventh surface
k = 0.000
A4 = −8.01347e−05, A6 = 1.02070e−06, A8 = −2.17639e−08,
A10 = 1.21592e−10
Twelfth surface
k = 0.000
A4 = −2.45771e−05, A6 = 1.65806e−07, A8 = −1.09561e−08
Thirteenth surface
k = 0.000
A4 = 3.50479e−05, A6 = 1.38213e−07, A8 = −1.07533e−08
Nineteenth surface
k = 0.000
A4 = 3.89480e−05, A6 = 3.56949e−07
Twentieth surface
k = 0.000
A4 = 5.30699e−05, A6 = 3.48499e−07, A8 = −7.88191e−09,
A10 = 7.32173e−11

Zoom data

| | WE | ST2 | TE | ST1 | ST3 |
|---|---|---|---|---|---|
| f | 12.35 | 23.34 | 44.08 | 16.99 | 31.99 |
| FNO. | 4.08 | 4.08 | 4.08 | 4.08 | 4.08 |
| 2ω | 90.77 | 50.68 | 27.49 | 68.10 | 37.59 |
| BF (in air) | 15.29 | 15.29 | 15.29 | 15.29 | 15.29 |
| LTL (in air) | 88.73 | 91.79 | 109.01 | 89.38 | 97.32 |
| d3 | 0.76 | 10.54 | 25.42 | 5.48 | 16.01 |
| d10 | 22.26 | 8.74 | 2.40 | 14.77 | 4.40 |
| d18 | 2.59 | 7.40 | 10.46 | 4.66 | 10.06 |
| d20 | 5.20 | 7.20 | 12.81 | 6.55 | 8.94 |

Respective group focal lengths

| | | | | |
|---|---|---|---|---|
| f1 = 85.12 | f2 = 44.07 | f3 = 18.39 | f4 = −29.14 | f5 = 43.07 |

### Numerical Example 5

Unit mm
Surface data

| Surface number | r | d | nd | νd |
|---|---|---|---|---|
| 1 | 64.187 | 1.80 | 1.92286 | 18.90 |
| 2 | 46.666 | 5.30 | 1.77250 | 49.60 |
| 3 | 683.917 | variable | | |
| 4 | 66.797 | 1.20 | 1.83481 | 42.74 |
| 5 | 9.924 | 6.61 | | |
| 6* | −27.381 | 0.90 | 1.58313 | 59.38 |
| 7* | 40.437 | 0.70 | | |
| 8 | 35.783 | 3.41 | 2.00100 | 29.13 |
| 9 | −46.590 | 0.60 | 1.71999 | 50.23 |
| 10 | 2484.308 | variable | | |
| 11 (aperture) | ∞ | 1.00 | | |
| 12* | 22.684 | 2.45 | 1.88202 | 37.22 |
| 13* | 125.486 | 1.73 | | |
| 14 | 20.103 | 4.26 | 1.49700 | 81.54 |
| 15 | −26.196 | 0.20 | | |
| 16 | 124.417 | 0.60 | 1.91082 | 35.25 |
| 17 | 10.311 | 4.89 | 1.43875 | 94.66 |
| 18 | −20.403 | variable | | |
| 19* | −69.514 | 1.00 | 1.53071 | 55.69 |
| 20* | 20.861 | variable | | |
| 21 | 26.060 | 5.12 | 1.51633 | 64.14 |
| 22 | −148.077 | 11.54 | | |
| 23 | ∞ | 4.11 | 1.51633 | 64.14 |
| 24 | ∞ | 2.00 | | |
| Image plane | ∞ | | | |

Aspherical data

Sixth surface
k = 0.000
A4 = 2.32106e−05, A6 = −6.73864e−07, A8 = 3.65707e−10,
A10 = −1.75309e−11
Seventh surface
k = 0.000
A4 = −1.47597e−05, A6 = −6.67422e−07, A8 = −3.23415e−09,
A10 = 3.59203e−11
Twelfth surface
k = 0.000
A4 = −2.02810e−05, A6 = −1.40233e−07, A8 = −1.18740e−08
Thirteenth surface
k = 0.000
A4 = 2.49252e−05, A6 = −1.84237e−07, A8 = −1.05454e−08
Nineteenth surface
k = 0.000
A4 = 5.75071e−05, A6 = 1.43135e−07
Twentieth surface
k = 0.000
A4 = 7.64147e−05, A6 = −5.25913e−08, A8 = −1.29415e−09,
A10 = 9.74977e−12

Zoom data

| | WE | ST2 | TE | ST1 | ST3 |
|---|---|---|---|---|---|
| f | 12.35 | 23.34 | 44.08 | 16.99 | 32.07 |
| FNO. | 4.08 | 4.08 | 4.27 | 4.08 | 4.08 |
| 2ω | 90.82 | 50.55 | 27.49 | 68.01 | 37.35 |
| BF (in air) | 16.25 | 16.25 | 16.25 | 16.25 | 16.25 |
| LTL (in air) | 88.73 | 94.95 | 113.50 | 90.60 | 103.48 |
| d3 | 0.78 | 12.38 | 28.35 | 6.11 | 20.11 |
| d10 | 22.40 | 9.32 | 2.41 | 15.05 | 5.44 |
| d18 | 2.59 | 7.40 | 11.87 | 4.71 | 9.70 |
| d20 | 4.94 | 7.83 | 12.85 | 6.72 | 10.21 |

Respective group focal lengths

| | | | | |
|---|---|---|---|---|
| f1 = 98.79 | f2 = −14.48 | f3 = 18.67 | f4 = −30.12 | f5 = 43.35 |

### Numerical Example 6

Unit mm
Surface data

| Surface number | r | d | nd | νd |
|---|---|---|---|---|
| 1 | 50.739 | 1.80 | 1.92286 | 20.88 |
| 2 | 35.921 | 7.38 | 1.74400 | 44.78 |
| 3 | 175.912 | variable | | |
| 4* | 108.630 | 1.50 | 1.74320 | 49.34 |
| 5* | 11.658 | 6.61 | | |
| 6 | −34.172 | 1.00 | 1.49700 | 81.54 |
| 7 | 15.052 | 3.94 | 1.75520 | 27.51 |
| 8 | −138.862 | 1.40 | | |
| 9 | −19.181 | 0.80 | 1.79952 | 42.22 |
| 10 | −44.474 | variable | | |
| 11 (aperture) | ∞ | 1.00 | | |
| 12* | 22.335 | 3.20 | 1.74320 | 49.34 |
| 13* | −105.331 | 2.50 | | |
| 14 | −74.200 | 2.48 | 1.48749 | 70.23 |
| 15 | −17.507 | 0.54 | | |
| 16 | 101.551 | 1.00 | 1.80518 | 25.46 |
| 17 | 15.261 | 4.22 | 1.49700 | 81.61 |
| 18 | −21.591 | variable | | |
| 19* | −96.704 | 0.80 | 1.53071 | 55.69 |
| 20* | 16.538 | variable | | |
| 21. | 51.094 | 5.90 | 1.57501 | 41.50 |
| 22 | −32.468 | 11.40 | | |
| 23 | ∞ | 4.11 | 1.51633 | 64.14 |
| 24 | ∞ | 2.00 | | |
| Image plane | ∞ | | | |

Aspherical data

Fourth surface
k = 0.000
A4 = 5.14028e−05, A6 = −3.47798e−07, A8 = 1.85386e−09,
A10 = −6.14213e−12, A12 = 9.57363e−15
Fifth surface
k = 0.000
A4 = 4.00215e−05, A6 = −7.65187e−08
Twelfth surface
k = −0.085
A4 = 1.10195e−05, A6 = −2.14433e−07, A8 = 1.11172e−09,
A10 = −7.65781e−12
Thirteenth surface
k = 0.000
A4 = 9.68176e−05, A6 = −1.72007e−07
Nineteenth surface
k = 0.000
A4 = 4.87490e−05, A6 = −1.33851e−06, A8 = 1.23182e−08,
A10 = −1.03964e−11
Twentieth surface
k = 0.000
A4 = 5.43311e−05, A6 = −1.46674e−06, A8 = 1.18206e−08

Zoom data

| | WE | ST2 | TE | ST1 | ST3 |
|---|---|---|---|---|---|
| f | 12.34 | 22.93 | 44.22 | 16.63 | 31.85 |
| FNO. | 4.08 | 4.08 | 4.08 | 4.08 | 4.08 |
| 2ω | 89.02 | 50.63 | 26.79 | 68.66 | 36.98 |
| BF (in air) | 16.11 | 16.11 | 16.11 | 16.11 | 16.11 |
| LTL (in air) | 88.51 | 93.43 | 118.55 | 89.39 | 102.03 |
| d3 | 0.70 | 7.03 | 29.67 | 2.54 | 13.45 |
| d10 | 16.90 | 5.91 | 0.98 | 10.91 | 2.41 |
| d18 | 1.95 | 7.22 | 11.47 | 4.07 | 10.49 |
| d20 | 6.78 | 11.09 | 14.25 | 9.68 | 13.50 |

Respective group focal lengths

| | | | | |
|---|---|---|---|---|
| f1 = 106.67 | f2 = −12.39 | f3 = 16.38 | f4 = −26.55 | f5 = 35.44 |

### Numerical Example 7

Unit mm
Surface data

| Surface number | r | d | nd | νd |
|---|---|---|---|---|
| 1 | 53.345 | 1.70 | 1.89286 | 20.36 |
| 2 | 36.893 | 6.40 | 1.80400 | 46.58 |
| 3 | 185.366 | variable | | |
| 4* | 85.884 | 1.50 | 1.85135 | 40.10 |
| 5* | 10.950 | 5.53 | | |
| 6 | −24.418 | 1.00 | 1.67790 | 50.72 |
| 7 | 12.970 | 4.69 | 1.85478 | 24.80 |
| 8 | −36.207 | 1.09 | | |
| 9 | −17.049 | 0.80 | 2.00069 | 25.46 |
| 10 | −28.984 | variable | | |
| 11 (aperture) | ∞ | 1.50 | | |
| 12* | 16.400 | 3.40 | 1.74320 | 49.34 |
| 13* | −36.896 | 0.30 | | |
| 14 | 28.596 | 3.67 | 1.49700 | 81.61 |
| 15 | −16.044 | 0.70 | 1.91082 | 35.25 |
| 16 | 18.466 | 1.57 | | |
| 17* | 24.547 | 4.29 | 1.49700 | 81.61 |
| 18* | −13.255 | variable | | |
| 19 | −80.649 | 0.80 | 1.53071 | 55.69 |
| 20* | 17.285 | variable | | |
| 21 | 79.438 | 5.23 | 1.57099 | 50.80 |
| 22 | −29.018 | 11.17 | | |
| 23 | ∞ | 4.11 | 1.51633 | 64.14 |
| 24 | ∞ | 2.00 | | |
| Image plane | ∞ | | | |

Aspherical data

Fourth surface
k = 0.000
A4 = 2.79753e−05, A6 = −2.09995e−08
Fifth surface
k = 0.296
A4 = −1.04980e−05, A6 = −3.91025e−08
Twelfth surface
k = 0.000
A4 = −1.01739e−05, A6 = 1.04158e−09, A8 = 2.34445e−09
Thirteenth surface
k = 0.000
A4 = 2.83150e−05, A6 = −2.52838e−08, A8 = 2.14387e−09
Seventeenth surface
k = 0.000
A4 = −7.49659e−05, A6 = −1.45760e−07
Eighteenth surface
k = 0.000
A4 = 3.34194e−05, A6 = −1.00629e−07
Twentieth surface
k = 0.000
A4 = 1.21542e−05, A6 = −1.29713e−07, A8 = −6.02153e−10

Zoom data

| | WE | ST2 | TE | ST1 | ST3 |
|---|---|---|---|---|---|
| f | 12.35 | 23.41 | 44.10 | 17.09 | 31.99 |
| FNO. | 4.08 | 4.08 | 4.08 | 4.08 | 4.08 |
| 2ω | 90.00 | 49.53 | 26.53 | 66.72 | 36.61 |
| BF (in air) | 15.88 | 15.88 | 15.88 | 15.88 | 15.88 |
| LTL (in air) | 84.52 | 93.67 | 115.37 | 89.57 | 99.60 |
| d3 | 0.76 | 8.67 | 29.17 | 5.11 | 12.81 |
| d10 | 15.80 | 6.07 | 1.30 | 10.72 | 2.41 |
| d18 | 2.84 | 7.56 | 12.05 | 4.55 | 11.46 |
| d20 | 5.07 | 11.31 | 12.80 | 9.15 | 12.88 |

Respective group focal lengths

| | | | | |
|---|---|---|---|---|
| f1 = 96.96 | f2 = −11.66 | f3 = 16.67 | f4 = −26.75 | f5 = 37.89 |

### Numerical Example 8

Unit mm
Surface data

| Surface number | r | d | nd | νd |
|---|---|---|---|---|
| 1 | 48.797 | 1.70 | 1.92286 | 20.88 |
| 2 | 31.293 | 7.26 | 1.80610 | 40.92 |
| 3 | 182.938 | variable | | |
| 4 | 46.157 | 1.20 | 1.85150 | 40.78 |
| 5 | 10.458 | 4.69 | | |
| 6* | −41.423 | 1.00 | 1.85135 | 40.10 |
| 7* | 15.204 | 0.45 | | |
| 8 | 16.979 | 3.93 | 1.84666 | 23.78 |
| 9 | −47.382 | 1.04 | | |
| 10 | −18.478 | 0.80 | 1.78590 | 44.20 |
| 11 | −153.200 | 0.30 | | |
| 12 | 75.911 | 1.51 | 1.84666 | 23.78 |
| 13 | −165.929 | variable | | |
| 14 (aperture) | ∞ | 1.50 | | |
| 15* | 16.400 | 3.57 | 1.74320 | 49.34 |
| 16* | −41.487 | 0.41 | | |
| 17 | 20.960 | 3.99 | 1.49700 | 81.61 |
| 18 | −17.579 | 0.70 | 1.91082 | 35.25 |
| 19 | 14.357 | 1.54 | | |
| 20* | 17.332 | 4.67 | 1.49700 | 81.61 |
| 21* | −13.095 | variable | | |
| 22 | −95.943 | 0.80 | 1.53071 | 55.69 |
| 23* | 17.173 | variable | | |
| 24 | 128.492 | 5.02 | 1.54072 | 47.23 |
| 25 | −26.606 | 11.05 | | |
| 26 | ∞ | 4.11 | 1.51633 | 64.14 |
| 27 | ∞ | 2.00 | | |
| Image plane | ∞ | | | |

Aspherical data

Sixth surface
k = 0.000
A4 = 8.12307e−06, A6 = 4.78812e−08, A8 = −9.78051e−10
Seventh surface
k = 0.000
A4 = −1.18509e−05, A6 = 1.05772e−07
Fifteenth surface
k = 0.000
A4 = −2.51103e−05, A6 = −1.14034e−07, A8 = 3.07557e−09
Sixteenth surface
k = 0.000
A4 = −1.47365e−06, A6 = 4.26652e−08, A8 = 2.92239e−09
Twentieth surface
k = 0.000
A4 = −1.21392e−04, A6 = 4.96429e−07
Twenty−first surface
k = 0.000
A4 = 2.51925e−05, A6 = −3.13698e−08
Twenty−third surface
k = 0.000
A4 = 1.56587e−05, A6 = −2.17520e−07, A8 = 7.62091e−11

Zoom data

| | WE | ST2 | TE | ST1 | ST3 |
|---|---|---|---|---|---|
| f | 12.35 | 23.34 | 44.09 | 17.09 | 31.99 |
| FNO. | 4.08 | 4.08 | 4.08 | 4.08 | 4.08 |
| 2ω | 89.96 | 49.73 | 26.50 | 66.96 | 36.55 |
| BF (in air) | 15.76 | 15.76 | 15.76 | 15.76 | 15.76 |
| LTL (in air) | 84.51 | 91.57 | 115.59 | 89.58 | 99.59 |
| d3 | 0.76 | 5.07 | 27.04 | 3.53 | 10.68 |
| d13 | 14.05 | 4.80 | 1.30 | 9.54 | 1.89 |
| d21 | 2.83 | 8.46 | 12.03 | 4.42 | 12.24 |
| d23 | 5.03 | 11.40 | 13.38 | 10.26 | 12.95 |

Respective group focal lengths

| | | | | |
|---|---|---|---|---|
| f1 = 89.44 | f2 = 40.30 | f3 = 16.38 | f4 = −27.38 | f5 = 41.23 |

Values of condition expressions in each example are listed below. Note that “-” (hyphen) indicates that no corresponding component is provided.

| | | Example 1 | Example 2 | Example 3 | Example 4 |
|---|---|---|---|---|---|
| (1) | nd3f | 1.74 | 1.74 | 1.74 | 1.69 |
| (2) | (1/f3b)/(1/f3) | −0.08 | −0.03 | 0.00 | −0.22 |
| (3) | νd3bp − νd3bn | 46.29 | 49.22 | 49.22 | 46.29 |
| (4) | \|f4\|/\|f5\| | 0.70 | 0.70 | 0.73 | 0.68 |
| (5) | \|f2\|/ft | 0.32 | 0.27 | 0.31 | 0.32 |
| (6) | d23w/fw | 1.86 | 1.39 | 1.58 | 1.88 |
| (7) | \|f3\|/\|f2\| | 1.31 | 1.38 | 1.38 | 1.31 |
| (8) | nd3o | 1.74 | 1.74 | 1.74 | 1.69 |
| (9) | \|f1\|/\|f2\| | 5.90 | 7.32 | 6.14 | 6.05 |
| (10) | \|f1\|/ft | 1.86 | 2.00 | 1.88 | 1.93 |
| (11) | \|nd11 − nd12\| | 0.15 | 0.15 | 0.15 | 0.15 |
| | | Example 5 | Example 6 | Example 7 | Example 8 |
| (1) | nd3f | 1.88 | 1.74 | 1.74 | 1.74 |
| (2) | (1/f3b)/(1/f3) | −0.26 | 0.19 | — | — |
| (3) | νd3bp − νd3bn | 59.41 | 56.15 | — | — |
| (4) | \|f4\|/\|f5\| | 0.69 | 0.75 | 0.71 | 0.66 |
| (5) | \|f2\|/ft | 0.33 | 0.28 | 0.26 | 0.23 |
| (6) | d23w/fw | 1.89 | 1.45 | 1.40 | 1.26 |
| (7) | \|f3\|/\|f2\| | 1.29 | 1.32 | 1.43 | 1.59 |
| (8) | nd3o | 1.88 | 1.74 | 1.74 | 1.74 |
| (9) | \|f1\|/\|f2\| | 6.82 | 8.61 | 8.31 | 8.68 |
| (10) | \|f1\|/ft | 2.24 | 2.41 | 2.20 | 2.03 |
| (11) | \|nd11 − nd12\| | 0.15 | 0.18 | 0.09 | 0.12 |

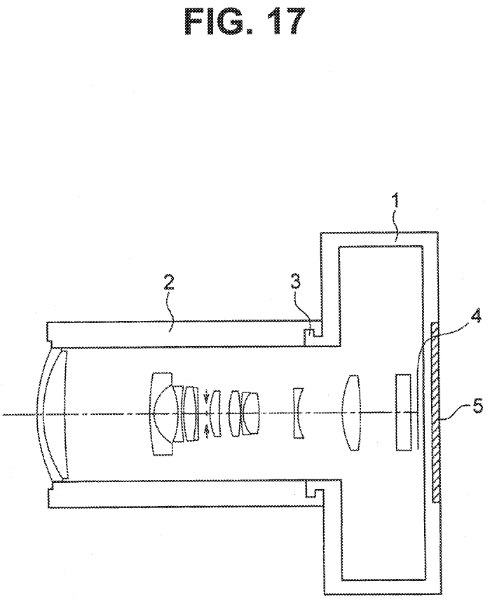

FIG. 17 is a cross-sectional view of a single-lens mirrorless camera as an electronic image pickup apparatus. In FIG. 17, a photographing optical system 2 is disposed in a barrel of the single-lens mirrorless camera 1. The photographing optical system 2 is detachably attached to a body of the single-lens mirrorless camera 1 through a mount unit 3. The mount unit 3 is, for example, a screw-type mount or a bayonet-type mount. In the example, the bayonet-type mount is used. In addition, an image pickup device surface 4 and a back monitor 5 are disposed in the body of the single-lens mirrorless camera 1. Note that, for example, a small-sized CCD or CMOS is used as the image pickup device.

For example, the zoom lens of Example 1 is used as the photographing optical system 2 of the single-lens mirrorless camera 1.

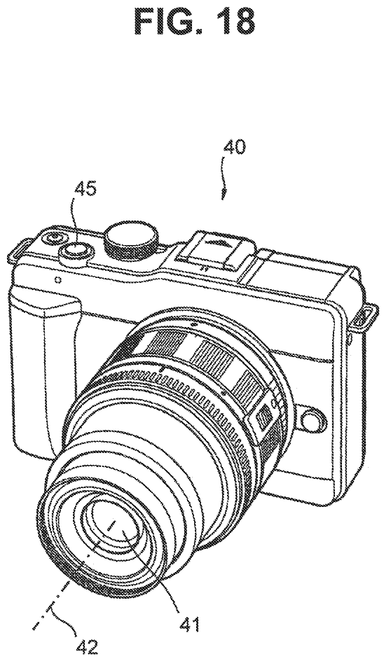

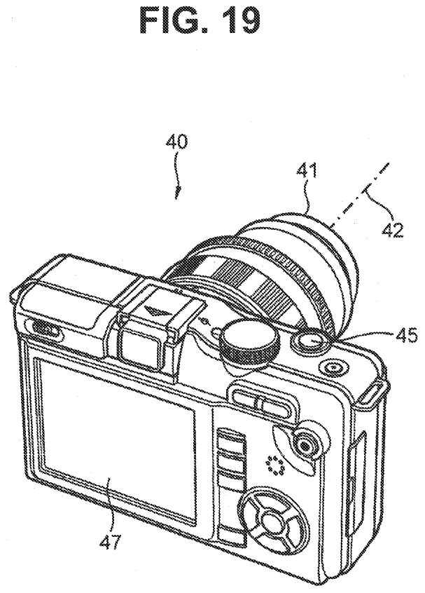

FIGS. 18 and 19 illustrate conceptual diagrams of a configuration of the image pickup apparatus. FIG. 18 is a front perspective view of a digital camera 40 as the image pickup apparatus, and FIG. 19 is a back perspective view of the digital camera 40. The zoom lens of the present example is used as a photographing optical system 41 of the digital camera 40.

The digital camera 40 of the present embodiment includes the photographing optical system 41, a shutter button 45, a liquid crystal display monitor 47, and the like, which are positioned on a photographing optical path 42. When the shutter button 45 disposed at an upper part of the digital camera 40 is pressed, photographing is performed through the photographing optical system 41, for example, the zoom lens of Example 1 in response to the press. An object image formed through the photographing optical system 41 is formed on the image pickup device (photoelectric conversion surface) provided near an image-forming plane. The object image received by the image pickup device is displayed on the liquid crystal display monitor 47, which is provided at a camera back surface, as an electronic image by a processing unit. The photographed electronic image may be recorded in a storage unit.

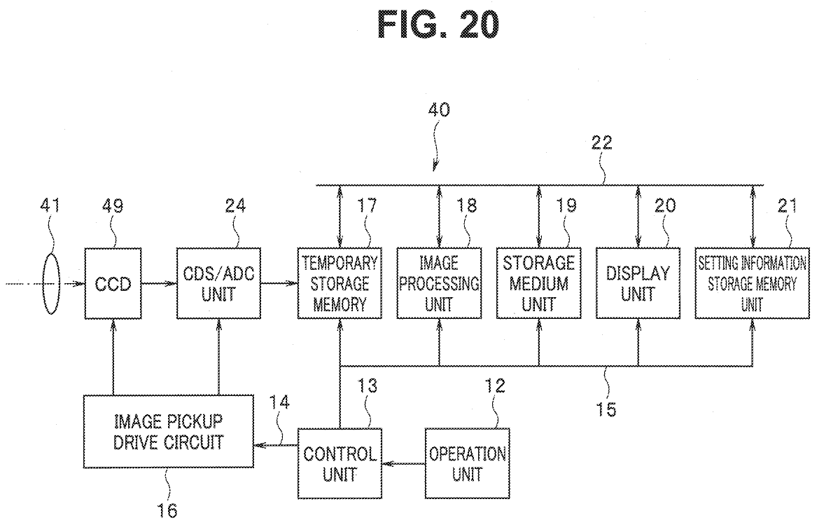

FIG. 20 is a block diagram illustrating an internal circuit of a main part of the digital camera 40. Note that, in the following description, the processing unit described above includes, for example, a CDS/ADC unit 24, a temporary storage memory 17, and an image processing unit 18, and the storage unit includes, for example, a storage medium unit 19.

As illustrated in FIG. 20, the digital camera 40 includes an operation unit 12, a control unit 13 connected to the operation unit 12, and an image pickup drive circuit 16, the temporary storage memory 17, the image processing unit 18, the storage medium unit 19, a display unit 20, and a setting information storage memory unit 21, which are connected to a control signal output port of the control unit 13 through buses 14 and 15.

The temporary storage memory 17, the image processing unit 18, the storage medium unit 19, the display unit 20, and the setting information storage memory unit 21 described above can perform mutual data input and output through a bus 22. In addition, a CCD 49 and the CDS/ADC unit 24 are connected to the image pickup drive circuit 16.

The operation unit 12 includes various input buttons and switches and notifies the control unit 13 of event information that is inputted from outside (camera user) through the buttons and switches. The control unit 13 is, for example, a central processing unit (CPU), includes a non-illustrated built-in program memory, and controls the entire digital camera 40 in accordance with a program stored in the program memory.

The CCD 49 is an image pickup device drive-controlled by the image pickup drive circuit 16 and configured to convert light quantity of each pixel of an object image formed through the photographing optical system 41 into an electric signal and output the electric signal to the CDS/ADC unit 24.

The CDS/ADC unit 24 is a circuit configured to perform amplification and analog/digital conversion of the electric signal inputted from the CCD 49, and output video raw data (Bayer data; hereinafter referred to as RAW data) provided only with the amplification and the digital conversion to the temporary storage memory 17.

The temporary storage memory 17 is a buffer made of, for example, an SDRAM and is a memory device configured to temporarily store the RAW data outputted from the CDS/ADC unit 24. The image processing unit 18 is a circuit configured to read the RAW data stored in the temporary storage memory 17 or RAW data stored in the storage medium unit 19 and electrically perform various kinds of image processing including distortion correction based on an image quality parameter specified by the control unit 13.

The storage medium unit 19 removably mounts a card-type or stick-type recording medium made of, for example, a flash memory, and records and stores, in the flash memory, RAW data forwarded from the temporary storage memory 17 and image data provided with image processing by the image processing unit 18.

The display unit 20 includes, for example, the liquid crystal display monitor 47 and displays photographed RAW data, image data, an operation menu, and the like. The setting information storage memory unit 21 includes a ROM unit in which various image quality parameters are stored in advance, and a RAM unit in which an image quality parameter read from the ROM unit upon an input operation through the operation unit 12 is stored.

Since the zoom lens of the present example is employed as the photographing optical system 41 of the digital camera 40, it is possible to achieve an image pickup apparatus capable of acquiring a clear image with small brightness change at zooming.

What is claimed is:

1. A zoom lens comprising, sequentially from an object side:
a first lens group having positive refractive power;
a second lens group having negative refractive power;
a third lens group having positive refractive power;
a fourth lens group having negative refractive power; and
a fifth lens group having positive refractive power; wherein
all intervals between each pair of adjacent lens groups change at zooming,
a distance between the fifth lens group and an image plane is constant,
the third lens group includes sequentially from the object side, a first positive lens, a second positive lens, and a cemented lens,
the first positive lens and the second positive lens are single lenses,
the cemented lens includes a negative lens and a positive lens, and
the zoom lens satisfies condition expressions (1) and (2) below:
1.63≤nd3f≤1.94 (1)
−0.39≤(1/f3b)/(1/f3)≤0.20 (2)
where,
nd3f represents a refractive index of the first positive lens disposed closest to the object side in the third lens group at a d line,
f3b represents a focal length of the cemented lens disposed closest to an image side in the third lens group, and
f3 represents a focal length of the third lens group.

2. The zoom lens according to claim 1, further comprising a brightness aperture between a surface of the second lens group on the image side and a surface of the third lens group on the object side.

3. The zoom lens according to claim 1, wherein
the zoom lens satisfies a condition expression (3) below:
41≤νd3bp−νd3bn≤65 (3)
where,
νd3bp represents a maximum Abbe number among Abbe numbers of the positive lens of the cemented lens disposed in the third lens group with respect to the d line, and
νd3bn represents a maximum Abbe number among Abbe numbers of the negative lens of the cemented lens with respect to the d line.

4. A zoom lens comprising, sequentially from an object side:
a first lens group having positive refractive power;
a second lens group having negative refractive power;
a third lens group having positive refractive power;
a fourth lens group having negative refractive power; and
a fifth lens group having positive refractive power, wherein
all intervals between each pair of adjacent lens groups change at zooming,
a distance between the fifth lens group and an image plane is constant,
the second lens group includes three or more negative lenses,
the fourth lens group comprises one single lens,
the fifth lens group comprises one single lens,
the fourth lens group moves along an optical axis at focusing, and
the zoom lens satisfies a condition expression (4) below:
0.59≤|f4|/|f5|≤0.91 (4)
where,
f4 represents a focal length of the fourth lens group, and
f5 represents a focal length of the fifth lens group.

5. The zoom lens according to claim 4, wherein the second lens group includes, sequentially from the object side, a negative lens, a negative lens, a positive lens, and a negative lens.

6. The zoom lens according to claim 4, wherein the zoom lens satisfies a condition expression (5) below:
0.17≤|f2|/ft≤0.39 (5)
where,
f2 represents a focal length of the second lens group, and
ft represents a focal length of a whole system of the zoom lens at a telephoto end.

7. A zoom lens comprising, sequentially from an object side:
a first lens group having positive refractive power;
a second lens group having negative refractive power;
a third lens group having positive refractive power;
a fourth lens group having negative refractive power, and
a fifth lens group having positive refractive power, wherein
all intervals between each pair of adjacent lens groups change at zooming,
a distance between the fifth lens group and an image plane is constant,
the third lens group includes a positive lens disposed closest to the object side, and
the zoom lens satisfies condition expressions (6), (7), and (8) below:
1.00≤d23w/fw≤1.94 (6)
1.24≤|f3|/|f2|≤1.48 (7)
1.63≤nd3o≤1.94 (8)
where,
d23w represents an air interval between the second lens group and the third lens group at a wide-angle end,
fw represents a focal length of a whole system of the zoom lens at the wide-angle end,
f2 represents a focal length of the second lens group,
f3 represents a focal length of the third lens group, and
nd3o represents a refractive index of the positive lens disposed closest to the object side in the third lens group at a d line.

8. A zoom lens comprising, sequentially from an object side:
a first lens group having positive refractive power;
a second lens group having negative refractive power;
a third lens group having positive refractive power;
a fourth lens group having negative refractive power, and
a fifth lens group having positive refractive power, wherein
all intervals between each pair of adjacent lens groups change at zooming,
a distance between the fifth lens group and an image plane is constant,
the third lens group includes a positive lens disposed closest to the object side, and
the zoom lens satisfies condition expressions (7), (8), and (9) below:
1.24≤|f3|/|f2|≤1.48 (7)
1.63≤nd3o≤1.94 (8)
5.00≤|f1|/|f2|≤8.74 (9)
where,
f1 represents a focal length of the first lens group,
f2 represents a focal length of the second lens group,
f3 represents a focal length of the third lens group, and
nd3o represents a refractive index of the positive lens disposed closest to the object side in the third lens group at a d line.

9. A zoom lens comprising, sequentially from an object side:
a first lens group having positive refractive power;
a second lens group having negative refractive power;
a third lens group having positive refractive power;
a fourth lens group having negative refractive power, and
a fifth lens group having positive refractive power, wherein
all intervals between each pair of adjacent lens groups change at zooming,
a distance between the fifth lens group and an image plane is constant,
the first lens group is one cemented lens including a negative lens and a positive lens,
the cemented lens includes an object-side lens positioned closest to the object side and an image-side lens positioned closest to an image side, and
the zoom lens satisfies condition expressions (10) and (11) below:
1.73≤|f1|/ft≤2.34 (10)
0.08≤|nd11−nd12|≤0.17 (11)
where,
f1 represents a focal length of the first lens group,
ft represents a focal length of a whole system of the zoom lens at a telephoto end,
nd11 represents a refractive index of the object-side lens positioned closest to the object side among the lenses configuring the cemented lens disposed in the first lens group at a d line, and
nd12 represents a refractive index of the image-side lens positioned closest to the image side among the lenses configuring the cemented lens disposed in the first lens group at the d line.

10. The zoom lens according to claim 9, wherein
the object-side lens is the negative lens of the cemented lens, and
the image-side lens is the positive lens of the cemented lens.

11. An image pickup apparatus comprising:
an optical system; and
an image pickup device disposed at an image plane, wherein
the image pickup device includes an image pickup surface and converts an image formed on the image pickup surface through the optical system into an electric signal, and
the optical system is the zoom lens according to claim 1.

12. An image pickup apparatus comprising:
an optical system; and
an image pickup device disposed on an image plane, wherein
the image pickup device includes an image pickup surface and converts an image formed on the image pickup surface through the optical system into an electric signal, and
the optical system is the zoom lens according to claim 4.

13. An image pickup apparatus comprising:
an optical system; and
an image pickup device disposed on an image plane, wherein
the image pickup device includes an image pickup surface and converts an image formed on the image pickup surface through the optical system into an electric signal, and
the optical system is the zoom lens according to claim 7.

14. An image pickup apparatus comprising:
an optical system; and
an image pickup device disposed on an image plane, wherein
the image pickup device includes an image pickup surface and converts an image formed on the image pickup surface through the optical system into an electric signal, and
the optical system is the zoom lens according to claim 8.

15. An image pickup apparatus comprising:
an optical system; and
an image pickup device disposed on an image plane, wherein
the image pickup device includes an image pickup surface and converts an image formed on the image pickup surface through the optical system into an electric signal, and
the optical system is the zoom lens according to claim 9.
